(19) United States
(12) Patent Application Publication
(10) Pub. No.: US 2006/0188856 A1
(43) Pub. Date: Aug. 24, 2006

(54) Typing game machine

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/349,554

(22) Filed: Feb. 8, 2006

(30) Foreign Application Priority Data
Jan. 24, 2005 (JP) 2005-033509

(51) Int. Cl. G09B 13/00

(52) U.S. Cl. 434/227; 434/362

(57) ABSTRACT

There is provided a typing game machine which may increase a player's desire to play a game and an advertisement effect by displaying character arrays in various display manners, the character array being referred to as a determination reference for the true/false determination. The typing game machine performs a game that provides higher evaluation for higher matching rate between a predetermined character array and a character array inputted from the input device by comparing respective characters constituting the character arrays. A correct character array part and an incorrect character array part of the predetermined character array are displayed in different manners. The correct character array part comprises a character array having been inputted from the input means and determined to match the predetermined character array as opposed to the incorrect character array part.

### CROSS REFERENCE TO RELATED APPLICATIONS

This application is based upon and claims the benefits of priority from Japanese Patent Application No. 2005-033509 filed on Feb. 9, 2005, the entire contents of which are incorporated herein by reference. This application is also related to a co-pending U.S. patent application entitled “Typing Game Machine” and filed on Jan. 23, 2006 and being assigned to the same assignee as the present application. The co-pending application including specification, drawings and claims are expressly incorporated herein by reference in its entirety.

### FIELD OF THE INVENTION

The present invention relates to a typing game machine in which a game is conducted based on true/false determination by comparing a predetermined character array and a character array inputted through an input device operation by a player. More specifically, it relates to a typing game machine in which the predetermined character array being referred to as a determination reference of true/false determination is displayed in various manners based on true/false determination results such that the player's desire and an advertisement effect may be increased.

### RELATED ART

In the conventional typing game by which type input through a keyboard of a word processor or the like is practiced, a player types the keyboard within a predetermined period of time so as to input the same character array shown on a display or the like such that the player may learn the key arrangement by heart and acquire an effective typing skill. And such means with which the player can play the typing game may be a typing game machine of a cabinet type which is installed in an arcade or the like and with which unspecified many players can play the typing game by paying a predetermined fee and another typing game machine configured with each personal computer (PC) such that the typing game can be played with each PC by installing into each PC a typing game program (software) having been purchased by each player.

Further, as such a typing game machine, there has been introduced a typing game machine with which the player types not only a character array randomly displayed, but also conversation contents of characters displayed and lyrics of music played. For example, Japanese unexamined patent publication number 2002-268534 discloses a typing game machine in which the user types lyrics of practice music reproduced by a computer such that the player may improve his or her typing skill in precision and accurateness based on information obtained from his or her ears as opposed to a practice character array displayed on a screen.

And when game results of the typing game conducted in various manners are shown, not only acquired points or the number of characters the player has mistyped are displayed, but also other information is displayed. For example, Japanese unexamined patent publication number 2005-4064 discloses a typing machine in which mistyped character information is read and displayed in a graph or processed statistically such that the user can be provided with information of characters the user tends to mistype at a high probability (error probability). Thus, the user can practice typing the characters of the high error probability repeatedly such that the user may acquire the typing skill in a short period of time.

However, in the typing game machine disclosed in Japanese unexamined patent publication number 2005-4064, the player cannot be informed of which part of the character array the player has typed is mistyped although the player may recognize a kind of character (e.g., “f”, “u”, and so on) he or she mistyped in this game based on a screen displaying the game results. And in general the player may have specific kinds of characters and character arrays he or she tends to mistype and there may be common character arrays he or she mistype if a plurality of kinds of character arrays are continuously typed. However, in such a conventional typing game machine, the player is not informed of the character array having a correctly-typed character array part and an incorrectly-typed character array in a distinguishable manner, the player cannot recognize the character array which he or she may have trouble in typing.

### SUMMARY OF THE INVENTION

The present invention has been made on the above-described background and the player may be able to recognize visually part of the character array he or she could not typed correctly at the end of the game and may find a specific character array he or she has trouble in typing. Therefore, the player may become more desirous to play the game again. And it is possible to the character array used in the typing game again at the end of the game. Therefore, the advertisement effect on surrounding other potential players can be increased in the typing game machine.

According to the present invention, there is provided a typing game machine comprising: a display device; and an input device, wherein the typing game machine performs a game that provides higher evaluation for higher matching rate between a predetermined character array and a character array inputted from the input device in accordance with a game image displayed on the display device by comparing respective characters constituting the character arrays. The predetermined character array is displayed on the display device while a correct character array part and an incorrect character array part of the predetermined character array are displayed in different manners. Here, the correct character array part comprises a character array having been inputted from the input device and determined to match the predetermined character array. The incorrect character array part comprises a character array having been inputted from the input device and determined not to match the predetermined character array. Here, the input device may comprise a keyboard, a key pad, and other kinds of input devices. The keyboard may comprise a virtual keyboard.

Further features of the present invention, its nature, and various advantages will be more apparent from the accompanying drawings and the following description of the preferred embodiment.

### BRIEF DESCRIPTION OF THE DRAWINGS

FIG. 1 is a perspective view of a typing game machine according to this embodiment.

FIG. 2 shows general contents displayed on a first liquid crystal display prior to starting a typing game.

FIG. 3A shows general contents displayed on a second liquid crystal display while the typing game is in progress.

FIG. 3B is shows general contents displayed on the second liquid crystal display while the typing game is in progress.

FIG. 3C shows general contents (English lyrics) displayed on a second liquid crystal display while the typing game is in progress.

FIG. 4A shows general contents displayed on the second liquid crystal display while the typing game is in progress.

FIG. 4B shows general contents displayed on the first liquid crystal display while the typing game is in progress.

FIG. 4C shows general contents displayed on the first liquid crystal display while the typing game is in progress.

FIG. 5A shows general contents displayed on the second liquid crystal display upon completion of the typing game.

FIG. 5B shows general contents displayed on the first liquid crystal display upon completion of the typing game.

FIG. 5C shows general contents (English lyrics) displayed on the first liquid crystal display upon completion of the typing game.

FIG. 6 shows general contents displayed on the first liquid crystal display after displaying the game result screen.

FIG. 7A illustrates a display manner of a displayed character array in a lyrics display result screen according to this embodiment.

FIG. 7B illustrates a display manner of a displayed character array (English lyrics) in a lyrics display result screen according to this embodiment.

FIG. 8A illustrates a display manner of a displayed character array in a lyrics display result screen according to another embodiment.

FIG. 8B illustrates a display manner of a displayed character array (English lyrics) in a lyrics display result screen according to another embodiment.

FIG. 9A illustrates a display manner of a displayed character array in a lyrics display result screen according to another embodiment.

FIG. 9B illustrates a display manner of a displayed character array (English lyrics) in a lyrics display result screen according to another embodiment.

FIG. 10A illustrates a display manner of a displayed character array in a lyrics display result screen according to another embodiment.

FIG. 10B illustrates a display mer of a displayed character array (English lyrics) in a lyrics display result screen according to another embodiment.

FIG. 11A is a plan view of a keyboard provided to the typing game machine of this embodiment.

FIG. 11B is a plan view of another keyboard which may be used in the typing game machine of this embodiment.

FIG. 11C is a plan view of another keyboard which may be used in the typing game machine of this embodiment.

FIG. 12 is a schematic cross-sectional view of one of plurality of keys provided on the keyboard.

FIG. 13 is a system block diagram showing a system comprising the typing game machine and a server of this embodiment.

FIG. 14 is a block diagram showing graphically a control system of the typing game machine according to this embodiment.

FIG. 15 is a schematic view of a music data storage area of the HDD in the typing game machine of this embodiment.

FIG. 16 is a flow chart of the main process program for the typing game machine according to this embodiment.

FIG. 17 is a flow chart of a music selection process program for the typing game machine according to this embodiment.

FIG. 18 is a flow chat of a typing game conduction process program for the typing game machine according to this embodiment.

FIG. 19 is a flow chart of a game result display process program for the typing game machine according to this embodiment.

FIG. 20A shows general contents displayed on the second liquid crystal display upon completion of the typing game according to another embodiment.

FIG. 20B shows general contents displayed on the first liquid crystal display upon completion of the typing game according to another embodiment.

FIG. 20C shows general contents (English lyrics) displayed on the second liquid crystal display upon completion of the typing game according to another embodiment.

### DESCRIPTION OF THE PREFERRED EMBODIMENT

In the following description, according to the present invention, a detailed explanation will be made for a typing game machine, for example, a cabinet-type typing game machine installed at a game arcade and the like in reference to the figures. In this instance, the typing game machine 1 of this embodiment is constituted in such a manner that a musical composition is reproduced from speakers, lyrics are displayed segment by segment on a display as the reproduced musical composition is streamed, and a player uses a keyboard to type the thus displayed lyrics in sequence, thereby playing a game. Further, the typing game to be played is constituted of a plurality of stages according to the total number of tune numbers of musical compositions to be reproduced, and when the player makes typing errors less than a predetermined number at the completion of one stage, the player can proceed to a stage which corresponds to the next tune number of the musical composition, thereby continuing to play the typing game. Further, the typing game to be played is constituted of a plurality of stages according to the total number of tune numbers of musical compositions to be reproduced, and when the player makes typing errors less than a predetermined number at the completion of one stage, the player can proceed to a stage which corresponds to the next tune number of the musical composition, thereby continuing to play the typing game.

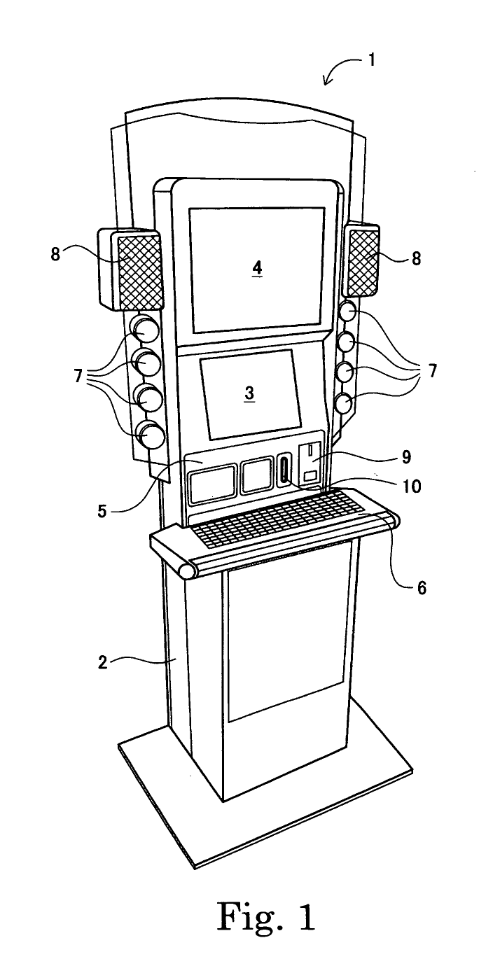

In the following description, an explanation will be made for a general constitution of the typing game machine 1 of this embodiment in reference to FIG. 1. FIG. 1 is a perspective view of the typing game machine of this embodiment.

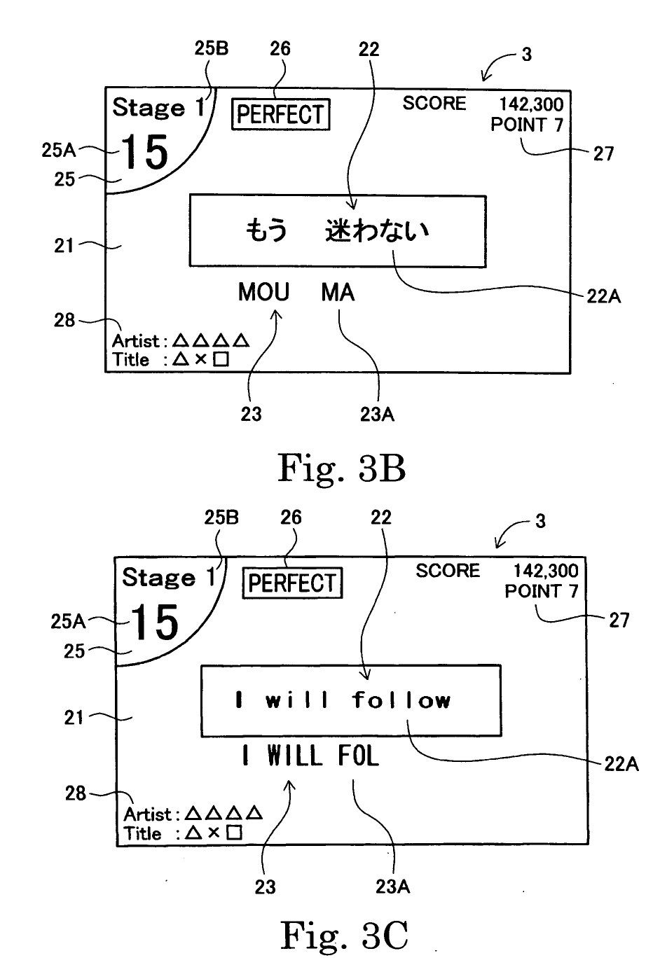

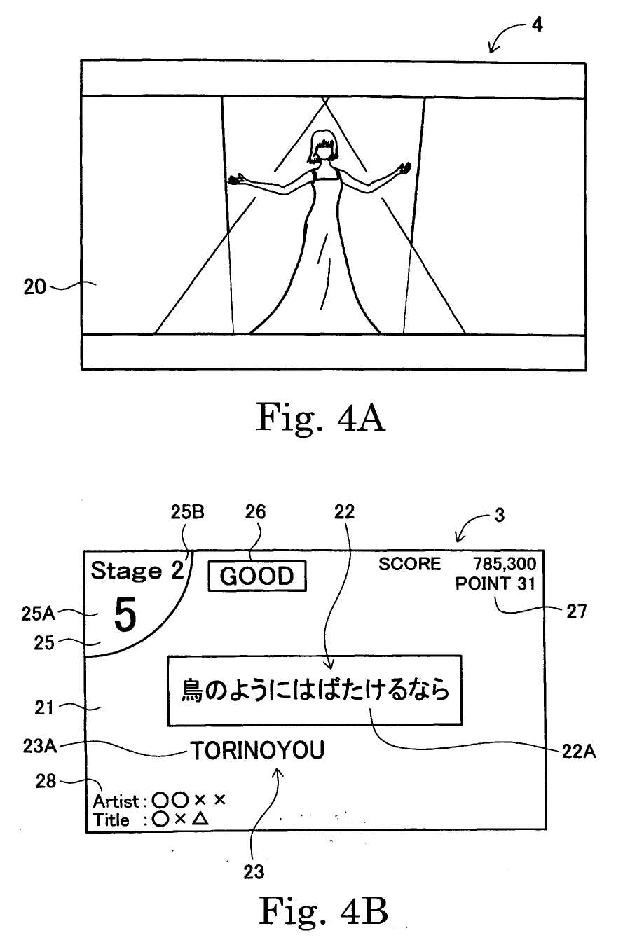

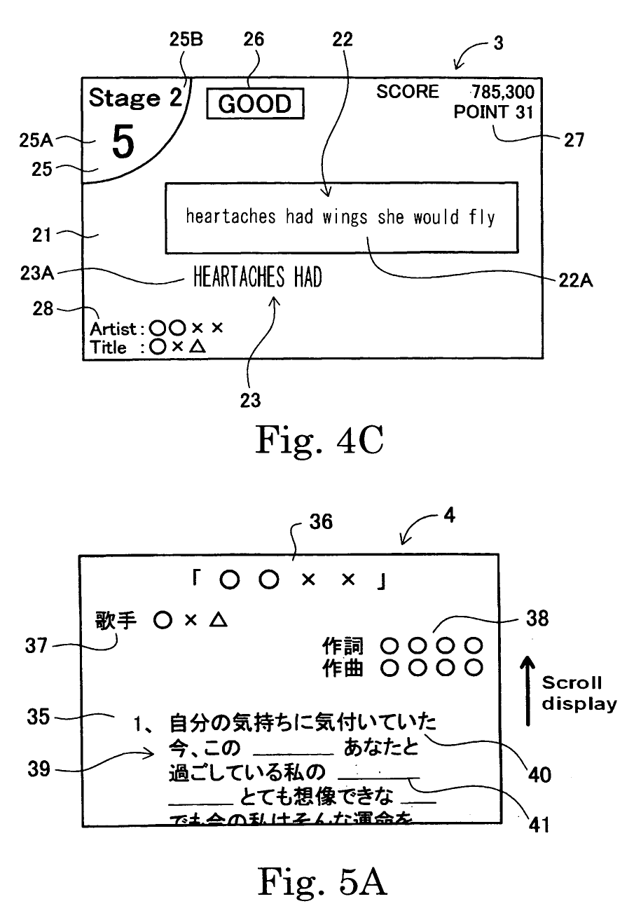

As shown in FIG. 1, the typing game machine 1 of this embodiment is basically composed of a cabinet 2 forming a general outer shape of the typing game machine 1, a first liquid crystal display 3 (1st LCD) to display a main game screen (refer to FIGS. 3B, 3C, 4B and 4C), a second liquid crystal display 4 (2nd LCD), which is disposed above the first liquid crystal display 3, to display a promotion video and images of effects for advertisement (refer to FIGS. 3A and 4A), a center panel 5, which is disposed under the first liquid crystal display 3, having insertion openings for a coin and a card, a keyboard 6 on which the player types, an emission light 7 disposed on both sides (right and left sides) of the first liquid crystal display 3, a pair of speakers 8 disposed on both sides (right and left sides) of the second liquid crystal display 4. Each constituting element will be explained as follows.

The first liquid crystal display 3 is a liquid crystal display disposed approximately at the center of the front face of the cabinet 2 in a state of being inclined with a predetermined angle, and the display 3 is thus slanted backward at a predetermined angle.

Then, the first liquid crystal display 3 displays lyrics of the musical composition reproduced from the speakers 8, results of typing operation by the player and game information on the progress of the typing game such as scores thereof (information necessary for the player to conduct the game) upon execution of the typing game (refer to FIGS. 3B, 3C, 4B and 4C).

Then, the second liquid crystal display 4 disposed separately above the first liquid crystal display 3 is a liquid crystal display similar to the first liquid crystal display, however, the second liquid crystal display 4 displays effect images of the effects of the typing game when the typing game is conducted.

In this instance, the effect images displayed on the second liquid crystal display 4 are different from those on the first liquid crystal display 3 in the content thereof, and not directly necessary for the player to conduct the game, but the effect images may assume an auxiliary role in warming up the typing game. For example, in the typing game machine 1 of the embodiment 1, a musical composition of a certain singer is reproduced for the musical composition of the game and the player uses the keyboard 6 to enter lyrics of the musical composition as the game proceeds. A promotion video (hereinafter abbreviated as “PV”) related to the musical composition is shown on the second liquid crystal display 4 (refer to FIGS. 3A and 4A). Therefore, the player can play the typing game in an environment of a pseudo-live show that an artist who is singing a song is shown as the musical composition is played such that the player may not get bored with the game.

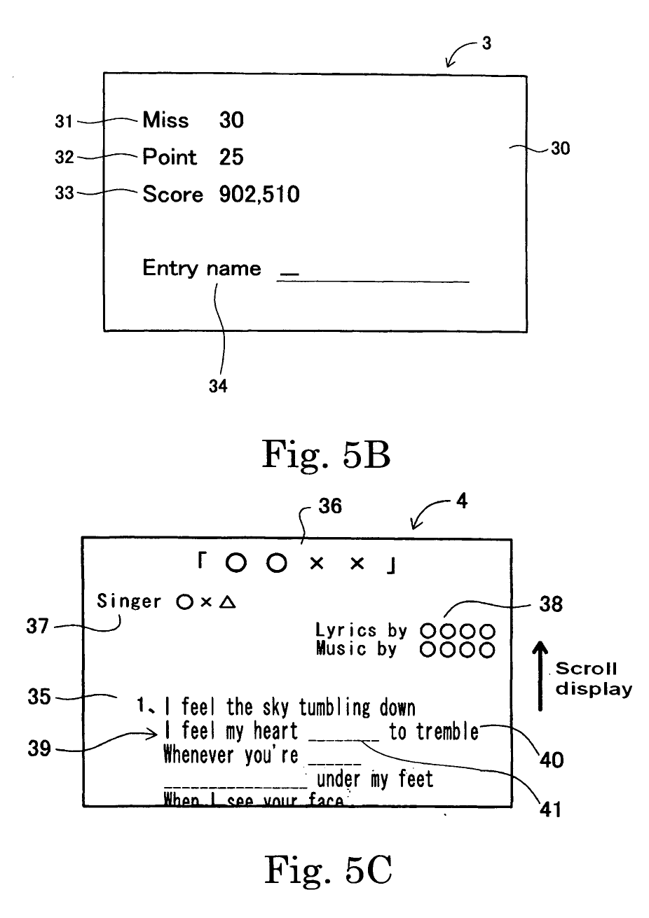

And the first liquid crystal display 3 displays a game result screen 30 (refer to FIG. 5B) at the end of the game and the second liquid crystal display 4 displays a lyrics display result screen 35 (refer to FIG. 5A) showing a title of the reproduced musical composition and lyrics thereof used in this typing game in various manners based on the true/false determination result of the player's typing. A detailed explanation will be made later for the contents displayed on the first liquid crystal display 3 and the second liquid crystal display 4.

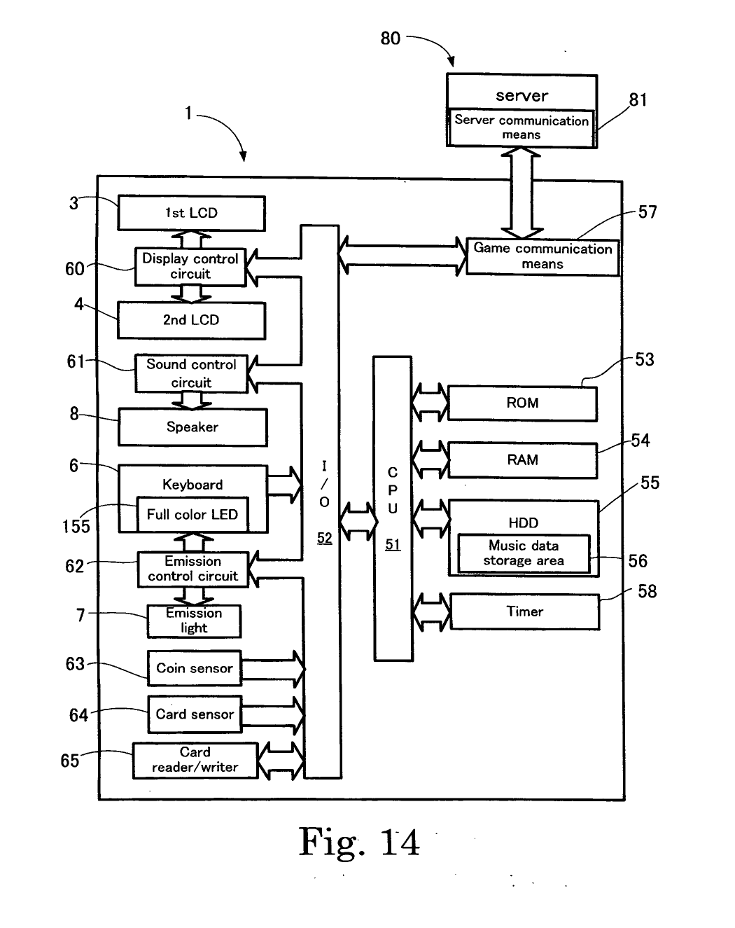

Further, a center panel 5 is provided with a coin insertion slot 9 and a card insertion slot 10. The coin insertion slot 9 is an insertion slot into which coins such as 100-Japanese-yen coins (or quarters in the US dollar) are inserted. A coin sensor 63 is disposed on the coin insertion slot 9, and when coins are inserted into the coin insertion slot 9, a coin detection signal is output to a CPU 51 via the coin sensor 63 (refer to FIG. 14) and the CPU 51 detects that coins have been inserted.

In addition, the card insertion slot 10 is an insertion slot into which an IC card (not illustrated) with a built-in IC tag to record results of the typing game is inserted. A card sensor 64 to be explained later and a card reader/writer 65 are arranged inside the card insertion slot (refer to FIG. 14). Where the IC card is inserted into the card insertion slot 10, the card sensor 64 detects this card insertion. In this instance, the IC card used in the typing game machine 1 of the embodiment 1 stores game results obtained by the player up to the previous game (acquired scores, points and others) which are possessed in the built-in IC tag, making it possible to display the thus stored game results to the player by a predetermined operation.

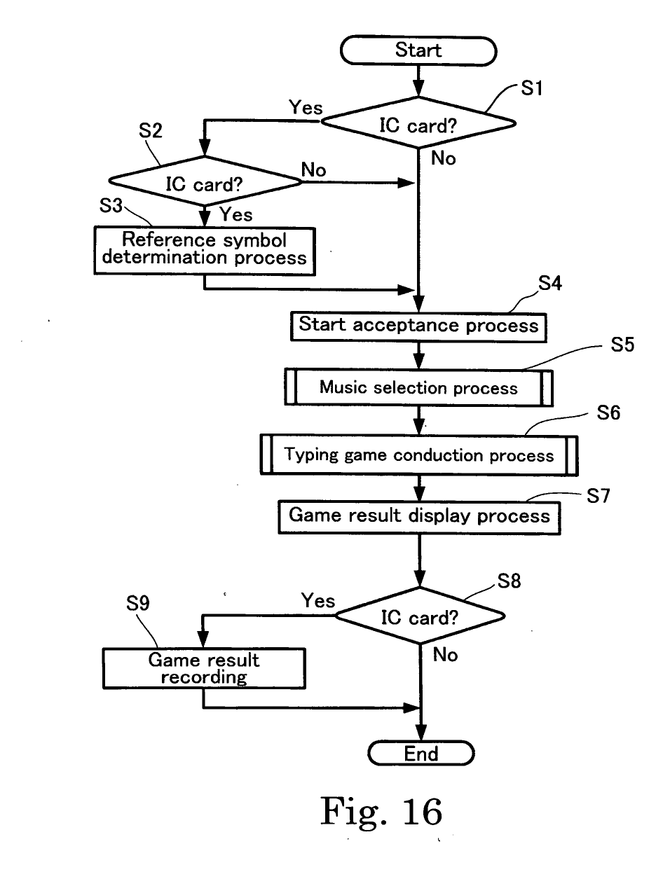

To be more specific, where the IC card is detected by the card sensor 64, the card reader/writer 65 reads the game results of the typing game from the IC tag or writes new game results into the IC tag (S3 and S9 in FIG. 16).

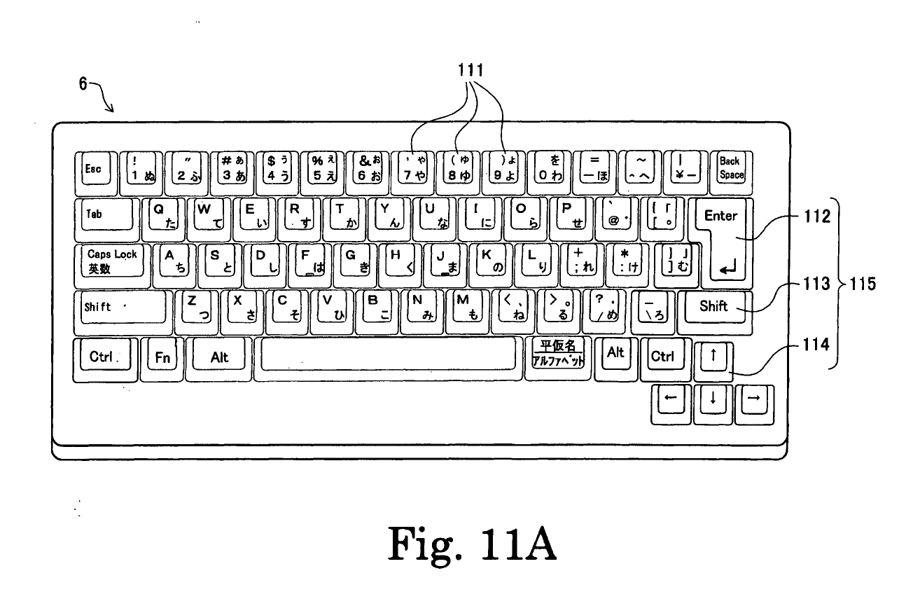

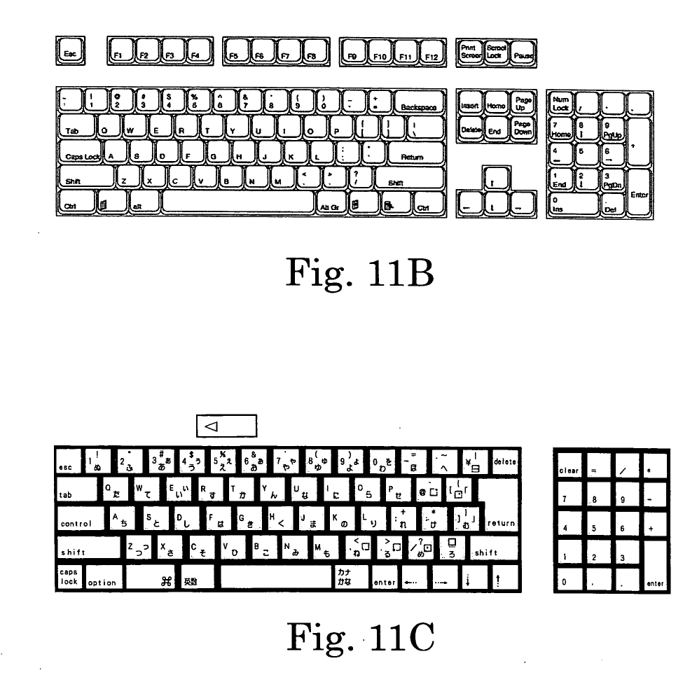

The keyboard 6 is arranged in front of the cabinet 2 in a state of being projected forward, and as will be explained later, it is a Japanese language keyboard 108 in which a plurality of character enter keys for entering “alphabetic letters (A to Z),” “‘Kana [Japanese syllabary]’ (‘a’ to ‘n’),” “numerals (0 to 9) and “symbols (period and comma)” as well as function keys such as the enter key and cursor key are individually arranged (refer to FIG. 11). Then, while the game is in progress, the player types individual keys corresponding to characters, symbols, numerals and others, entering characters to advance the game. Further, prior to starting the game or after completion of the game, the player gives instructions to select and decide musical compositions for the game or the degree of difficulty or to start and execute the game by operating individual keys. Meanwhile, a detailed explanation will be made later for the configuration of the keyboard.

Four emission lights 7 are arranged on each of the right and left sides of the cabinet 2. The emission lights 7 are composed of full-color LEDs which can emit a full color and provide a variety of illumination effects according to musical compositions reproduced in the typing game machine 1. For example, the illumination effects include color changes of eight emission lights 7 in all, changes of illumination colors in a predetermined pattern, and blinking the emission lights 7.

Further, the speakers 8 are arranged on the right and left sides of the second liquid crystal display 4. The speakers 8 are output devices for outputting musical compositions, which are composed of a musical accompaniment and a voice of the artist, effect sounds and the like that are reproduced in the typing game machine 1. To be more specific, in conducting the typing game, the speakers 8 output music and sound at a predetermined tempo on the basis of audio data and performance data of musical compositions stored in the HDD 55 (refer to FIG. 14).

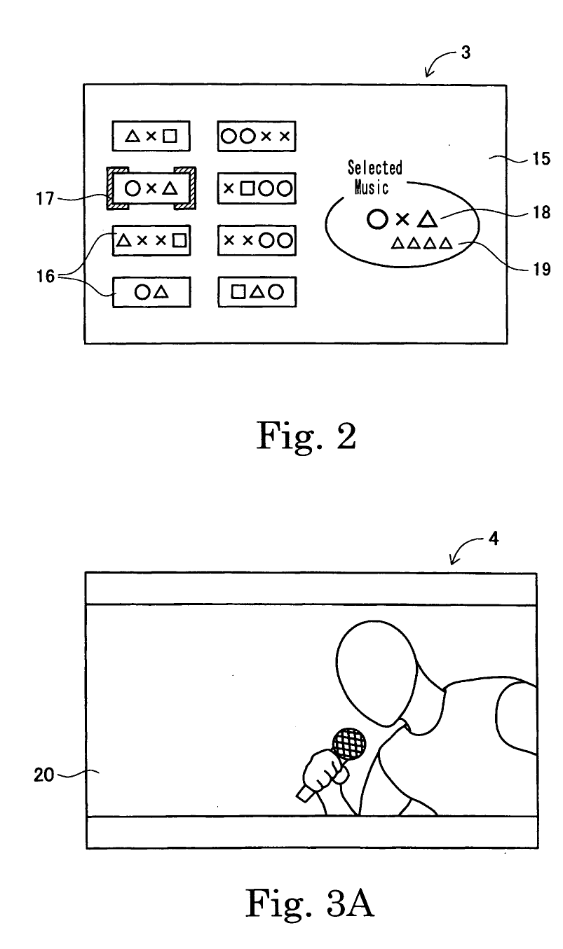

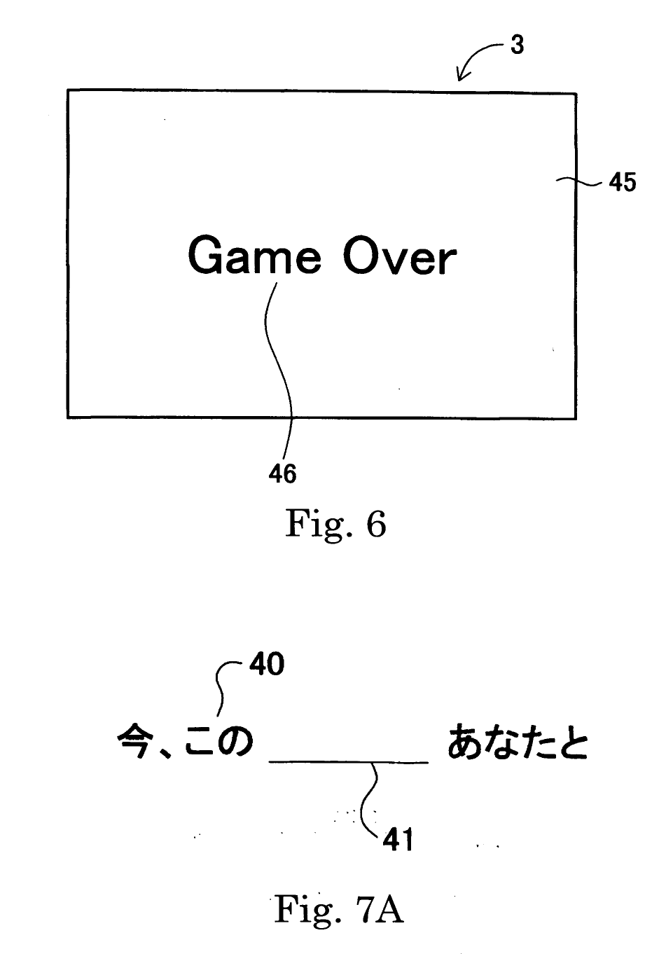

Next, a detailed explanation will be made for contents displayed on the first liquid crystal display 3 and the second liquid crystal display 4 in reference to FIGS. 2 to 6. The contents displayed on the first liquid crystal display 3 and the second liquid crystal display 4 are basically composed of three patterns, namely, a pattern before the beginning of the typing game, a pattern during the typing game, and a pattern after the completion of the typing game. FIG. 2 is a pattern diagram showing the contents displayed on the first liquid crystal display 3 before the typing game is started. FIGS. 3A and 4A show the contents displayed on the second liquid crystal display 4 while the typing game is in progress. FIGS. 3B and 4B show the contents displayed on the first liquid crystal display 3 while the typing game is in progress. FIGS. 3C and 4C show the contents (English lyrics) displayed on the first liquid crystal display 3 while the typing game is in progress. FIG. 5A shows the contents displayed on the second liquid crystal display 4 upon completion of the typing game. FIGS. 5B and 6 show the contents displayed on the first liquid crystal display 3 upon completion of the typing game. And FIG. 5C, in which English lyrics are used, shows the contents equivalent to those in FIG. 5B.

Here, the typing game machine 1 of this embodiment conducts the typing game as lyrics of a musical composition to be performed are entered. To be more specific, first, the player selects the musical composition to be played from a plurality of musical compositions which are made available. Then, upon starting the typing game, performance data corresponding to musical accompaniment of the thus selected musical composition and audio data corresponding to the singing voice of the artist of the musical composition are reproduced. Further, in association with reproduction of the performance data and the audio data of the musical composition, each phrase of the lyrics of the musical composition is displayed as a character array for the player to enter from the key board 6 in synchronization with the reproduced audio data.

Characters of the character array corresponding to one phrased of the lyrics being displayed are entered via the keyboard 6, thereby allowing the typing game to proceed. Upon completion of the game, results of the typing game (number of typing errors, acquired scores, points and others) are calculated and displayed on the basis of individual typing factors such as correctness of typing and entry timing. Namely, in the typing game of the typing game machine 1, the player competes in his or her skill level of typing characters and others as he or she enjoys the musical composition performed in the game.

First, an explanation will be made for contents displayed prior to starting the typing game in referring to FIG. 2. As shown in FIG. 2, on the first liquid crystal display 3, which is in a stage after a predetermined number of coins are inserted into the coin insertion slot 9 and before the typing game is started, a music selection screen 15 showing a list of musical compositions that can be played by the typing game machine 1 is displayed.

The music selection screen 15 is composed of a playable music title displaying part 16 which displays titles of playable musical compositions, a music selection cursor 17 which can select any of the playable musical compositions in the playable music title displaying part 16, a selected music title displaying part 18 which displays names of musical compositions selected by the music selection cursor 17 and a selected artist name displaying part 19 which displays artist names of the musical composition selected by the cursor.

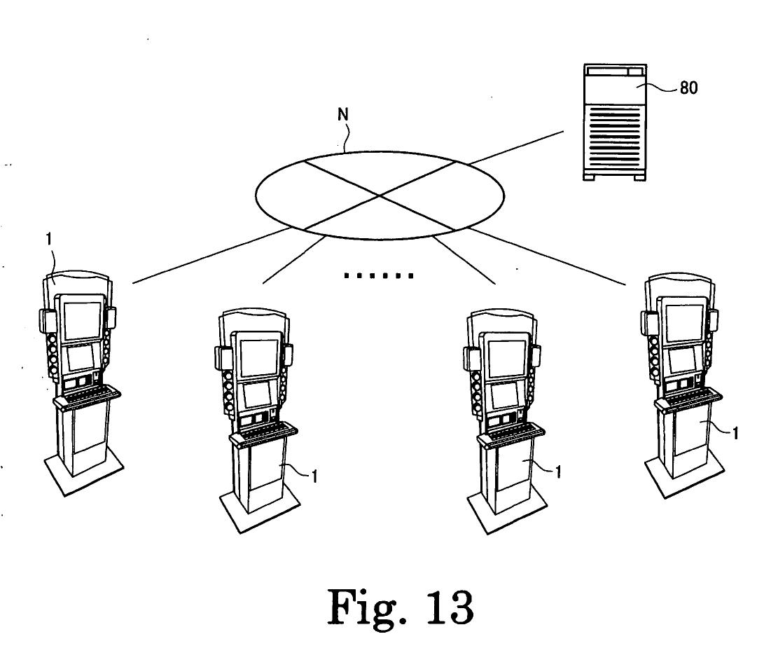

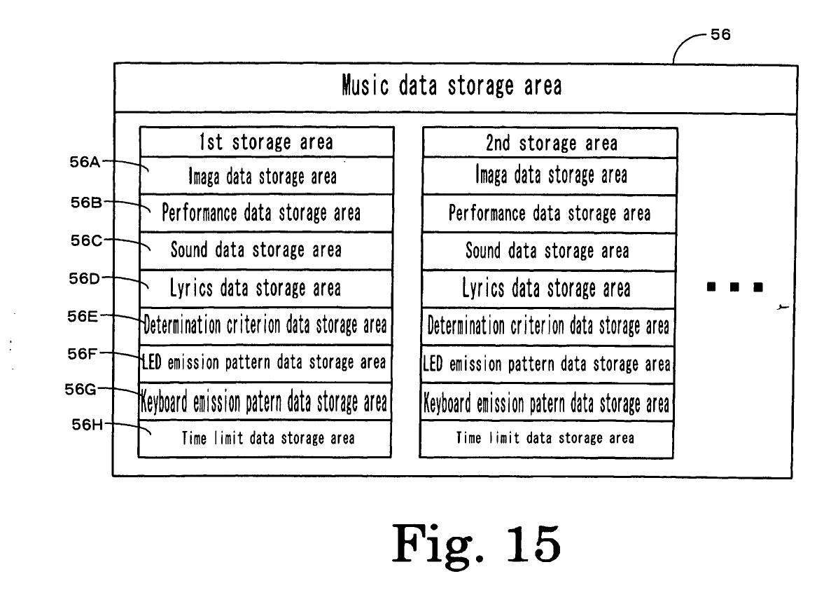

The playable music title displaying part 16 shows titles of playable musical compositions (up to 8 in this embodiment) which are available in the current typing game machine 1. In this instance, the playable musical compositions displayed in the playable music title displaying part 16 are musical compositions of which musical composition data (or music data) is stored in the HDD 55 that will be explained later (refer to FIGS. 14 and 15). Further, the stored music data is controlled by a server 80 (refer to FIG. 13), and renewed in sequence. Therefore, the player is allowed to conduct the game by selecting from a plurality of musical compositions including the latest musical compositions renewed by the server 80. Also, the playable music title displaying part 16 may display photos of an artist and PV, in addition to names of musical compositions.

In addition, the music selection cursor 17 can be moved vertically and horizontally on the playable music title displaying part 16 by operating a cursor key 114 on the keyboard 6 (refer to FIG. 1A). The selected music title displaying part 18 and the selected artist name displaying part 19 display the title of a musical composition and the name of an artist of the playable music title displaying part 16 at which the music selection cursor 17 is now located.

Then, when an enter key 112 (refer to FIG. 1A) is depressed in a state that the music selection cursor 17 is located at the playable music title displaying part 16 in which the title of a desired musical composition is displayed, the musical composition to be played is determined and a typing game is started.

While the music selection screen 15 is displayed on the first liquid crystal display 3, any given PV of musical compositions may be reproduced on the second liquid crystal display 4. Advertising images and others may also be provided. Further, the music selection screen 15 may be displayed not on the first liquid crystal display 3 but on the second liquid crystal display 4.

Next, an explanation will be made for contents displayed while a typing game is in progress in reference to FIGS. 3A to 4C. FIGS. 3A and 3B show the contents displayed on the first liquid crystal display 3 in which the predetermined musical composition ‘A’ performed by a male artist is selected on the music selection screen 15 to start the typing game. FIGS. 4A and 4B show the contents displayed on the second liquid crystal display 4 where the predetermined musical composition ‘B’ performed by a female artist is selected on the music selection screen 15 to start the typing game.

Here, FIGS. 3C and 4C also show, by way of example, the typing game with the same male and female artists, respectively, but with respective English lyrics thereof. Since the configuration other than the lyrics is the same, the duplicated explanation is omitted.

As shown in FIG. 3A, for example, where the musical composition ‘A’ is selected to start the game, a PV screen image 20 for the male artist who sings the musical composition ‘A’ reproduced via the speakers 8 is displayed on the second liquid crystal display 4. As shown in FIG. 4A, for example, where the musical composition ‘B’ is selected to start the game, the PV screen image 20 for the female artist who sings the musical composition ‘B’ reproduced via the speakers 8 is displayed on the second liquid crystal display 4.

On the other hand as shown in FIGS. 3B and 4B, a main game screen 21 related to the progress of the typing game is displayed on the first liquid crystal display 3, together with the display of the PV screen image 20 on the second liquid crystal display 4. The game procedures in FIGS. 3C and 4C are similar to those in FIGS. 3B and 4B, respectively.

In this instance, the main game screen 21 is constituted of a lyrics display part 22 which displays a phrase of the lyrics currently being performed in Chinese characters (Kanji), Japanese syllabary (Kana) and the like, a Roman character display part 23 which displays a character array 23A typed and entered by the player via the keyboard 6 in the Roman character (i.e., alphabet character), a musical-composition status displaying part 25 which displays what tune number (stage number) the phrase of the lyrics currently being displayed in the lyrics display part 22 belongs to and what number of the tune (or music) the phrase is in if counted from the beginning of the tune being performed, a type result displaying part 26 which displays the determination result of correct or incorrect typing by the player, a score displaying part 27 which displays scores, points and others so far acquired by the player and a music information displaying part 28 which displays the name of the artist and the music title now being performed.

The lyrics display part 22 is a displaying part which displays the character array 22A corresponding to one phrase of the lyrics of the musical composition now being performed and the game proceeds as the player operates the keyboard 6 to type the character array 22A displayed in the lyrics display part 22. Then, scores are gradually added when the player correctly types the phrases of the lyrics displayed, whereas scores are not added when he or she erroneously types characters irrespective of the lyrics and the number of typing errors is also added as the number of erroneous entries. When the number of typing errors exceeds a predetermined number after completion of any tune number, among the tune numbers (stages) constituting the musical composition, the game is instantly terminated (refer to S40 in FIG. 18).

And in the typing game machine of this embodiment, a character array part the player has mistyped during the game and failed to type within the period of time that a phrase of the character array is displayed is non-displayed (i.e., such a character array part is hidden or not shown) in the lyrics display result screen 35, which will be described later (refer to FIG. 5A).

The Roman character display part 23 is a region for newly displaying the character array 23A already typed by the player in Roman characters among character arrays 22 corresponding to the lyrics displayed in the lyrics display part 22. It is, therefore, possible to notify a player of characters so far typed.

Here, as described above, in the current embodiment, special keys such as a conversion key for converting ‘kana’ into ‘kanji’ (plus ‘kana’ if any) are not included or evaluated in the typing game. Therefore, even though the conversion key (in most cases, space key) is entered after “TORI”, the conversion key is not shown there. Also, as shown in FIG. 4C, the space key entered between words may be counted (or evaluated) or may not be counted in the typing game with English text, for which the conversion key is not necessary. For example, there is easier for the player to recognize words if space is automatically placed between the words although the typed space is not evaluated as well as the automatically inserted space.

Here, the player actually types Roman characters (i.e., alphabets) corresponding to the phrase of the lyrics, but the player may enter ‘kana’ as shown on the keyboard (Refer to FIG. 11A). Also, it can be configured that the player can select either prior to the game. Further, it is also possible to let the player type space or a key corresponding to the pause mark (similar to comma) between segments (bunsetsu in Japanese). Such game conditions may be set with the typing game machine and the player can confirm or choose the conditions prior to the typing game. Now, it is possible to allow the player to enter the characters in either way if more than one ways can be used to type Roman characters to express the same Japanese characters (e.g., Hepburn system and other systems).

Further, the musical composition status displaying part 25 is to display what tune number the phrase of the lyrics currently being displayed in the lyrics display part 22 belongs to and what number of the tune the phrase is in if counted from the beginning of the tune being performed. Here, the typing game of this embodiment is composed of a plurality of stages (for example, first to third stages) in accordance with the number of tune numbers of the musical compositions to be reproduced (for example, one musical composition is composed of tune numbers 1 to 3). For example, FIG. 3B now shows the 15th phrase of the first stage (tune number 1). Further, FIG. 4B now shows the 5th phrase of the stage 2 (tune number 2).

Then, a value 25A showing the phrase number is added one by one every time when entry of one phrase by a player is completed, and a value 25B showing the stage number (tune number) is added one by one every time when entry of one stage is completed. It is, therefore, possible to notify the player of the currently available stage number (tune number) and the phrase number so far completely typed.

The type result displaying part 26 is a part for displaying the determination result of correct or incorrect typing of the player, and when a corresponding correct character is typed at the same timing with the sound of the performed musical composition, “PERFECT” is displayed. Further, when a correct character is typed not at the same timing as the corresponding sound of the musical composition is performed, “GOOD” is displayed. On the other hand when a wrong character is typed irrespective of the timing of the sound, “MISS” is displayed.

The score displaying part 27 is a part for displaying the scores and points so far acquired by the player. In this instance, the score is added when characters are correctly typed according to the character array 22A displayed at the lyrics display part 22. Further, when the corresponding character is typed at the same timing as the corresponding sound of the musical composition is performed, an additional score is acquired. On the other hand one point is added every time when one phrase is typed completely without any typing errors (S36 in FIG. 18).

Further, the scores and points are added until completion of the game, and where an IC card is inserted into the card insertion slot 10 of the center panel 5, the scores and points acquired upon completion of the game are stored in the IC card (S9 in FIG. 16).

In addition, the music information displaying part 28 displays the title of a musical composition and the name of an artist which is selected by a player at the time of starting the game and now being performed.

In this embodiment, the main game screen 21 is to be displayed on the first liquid crystal display 3, and the PV screen image 20 is to be displayed on the second liquid crystal display 4. However, in contrast, the PV screen image 20 may be displayed on the first liquid crystal display 3 and the main game screen 21 may be displayed on the second liquid crystal display 4.

Next, an explanation for the contents displayed at the end of the typing game will be made in reference to FIGS. 5A to 6. FIGS. 5A and 5B shows respective display contents displayed on the first liquid crystal display 3 and the second liquid crystal display 4 at the end of the typing game. FIG. 6 shows contents displayed on the first liquid crystal display 3 after the game result screen is displayed. FIG. 5C, which shows English lyrics, is equivalent to FIG. 5A.

As shown in FIGS. 5A and 5B, in the typing game machine 1 of this embodiment, the game result screen 30 to show a list of the game results of this typing game is displayed on the first liquid crystal display 3 after the typing game is completed while the lyrics of the musical composition reproduced in this typing game are displayed on the second liquid crystal display 4. Thus, the lyrics display result screen 35 is displayed on the second liquid crystal display 4 again to show the whole lyrics of the character array 22A that comprise the characters the player has been supposed to type as they are displayed in the lyrics display part 22.

First, the game result screen 30 to be displayed on the first liquid crystal display 3 is explained. The game result screen 30 is composed of a typing-error number display part 31 which displays the number of typing errors (mistyped characters) made in this typing game, an acquisition point display part 32 which displays acquired points, an acquisition score display part 33 which displays acquired scores and a name entry display part 34 which prompts the game player to enter his or her name.

Then, by referring to the game result screen 30, the player knows the number of typing errors made in the current typing game and the acquired points and scores. Further, the player uses the keyboard 6 to enter any given name into the name entry display part 34, thereby making it possible to register the acquired scores in the ranking. A list of the thus registered ranking is displayed on the first liquid crystal display 3 or the second liquid crystal display 4 as a demonstration screen or the like.

And an explanation of the lyrics display result screen 35 displayed on the second liquid crystal display 4 as well as the game result screen 30 is made. The lyrics display result screen 35 is composed of a lyrics musical composition title display part 36 showing the title of the musical composition having been selected in the music selection screen 15 (refer to FIG. 2) and been performed as the typing game is being conducted, a lyrics artist name display part 37 showing the artist name of the musical composition, a lyrics-composition display part 38 showing a songwriter and a music composer, and a lyrics result display part 39 showing the lyrics (which are displayed in the lyrics display part 22 of the main game screen 21 and comprise the character array 22A the player is supposed to type) of the musical composition.

And the lyrics display result screen 35 is scrolled up for display at a predetermined rate to show the whole lyrics of the musical composition in the lyrics result display part 39. Then, when the lyrics display result screen 35 is erased after the whole lyrics are displayed, the game end screen 45 as shown in FIG. 6 replaces the game result screen 30 on the first liquid crystal display 3. As shown in FIG. 6, the game end screen 45 having the characters 46 of “Game Over” is displayed to inform the player of the complete end of the game.

Now, the lyrics displayed in the lyrics result display part 39 are explained. Here, the lyrics of the musical composition displayed in the lyrics result display part 39 are displayed in a manner that each phrase of the lyrics is displayed in each line such that the whole lyrics of the musical composition are shown. In addition, there are two more manners for displaying the lyrics. For example, a base character array part 40 of the lyrics may be displayed in one manner that the characters of the base character array 40 are displayed in a base font (e.g., in Gothic font and in white color) while an underline part 41 replacing a character array part of the lyrics is displayed in the other manner.

Here, in the lyrics display result screen 35, the lyrics of the musical composition may be displayed partially in the one manner that the base character array part 40 is displayed or in the other manner that the underline part 41 replaces the character array part 41 depending on the true/false determination result of the typing during the typing game. That is, the correctly typed character array part among the character array displayed in the lyrics display part 22 of the main game screen 21 is displayed with the base character array part 40 in the lyrics display result screen. While the incorrectly typed character array part is displayed without any actual characters to be typed in the lyrics display result screen 35, but with the underline part replacing the actual character array part. Here, the correctly typed character array part is determined to be the character array part, characters of which are typed correctly during displaying the corresponding character array 22A in the lyrics display part 22 irrespective of synchronization with the voice reproduction of the performed musical composition.

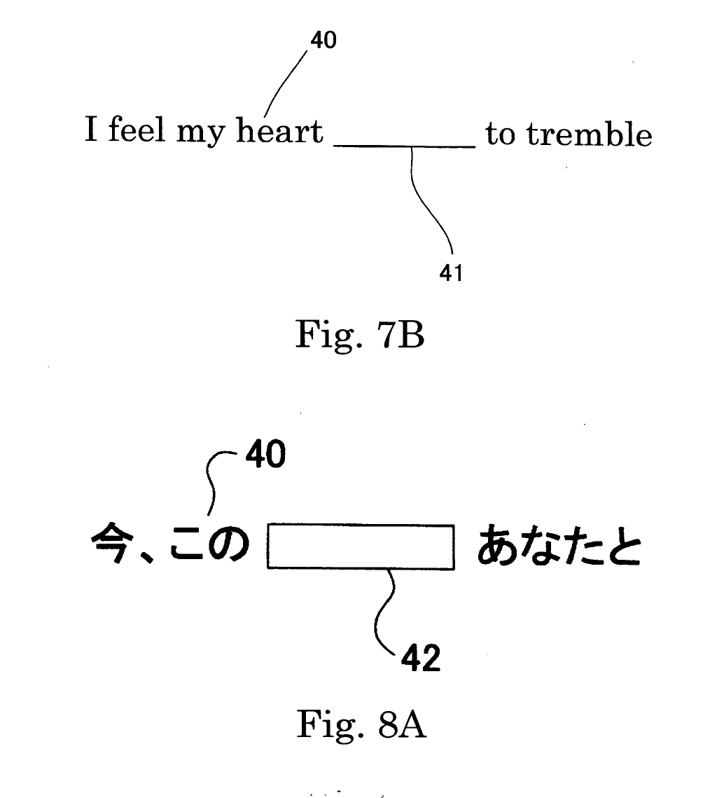

For example, as shown in FIGS. 5A and 7A, if “jikanwo” of the character array part in “ima, konojikanwoanatato” of the second phrase character array is not correctly typed, “jikanwo” of the character array part is not displayed, but substituted with the underline part 41 and “ima, kono” and “anatato” are displayed in the base character array part 41.

FIGS. 5C and 7B, in which English lyrics are used, are equivalent to FIGS. 5A and 7A. Therefore, the other components than the lyrics are identical so that a duplicated explanation is omitted. The lyrics comprises:

“I feel the sky tumbling down

I feel my heart starting to tremble

Whenever you're around

The earth moves under my feet

When I see your face.”

Among the lyrics, “starting”, “around” and “The earth moves” are not typed correctly such that the underline parts 41 are displayed instead. The other parts are displayed with the base character array parts 40.

Thus, in the typing game machine of this embodiment, the whole lyrics of the musical composition having been used in the typing game are again displayed at the end of the typing game and the character array part the player has failed to type correctly during the typing game being conducted is displayed in a different manner from the manner in which the character array part having been typed correctly is displayed. Therefore, the player can recognize easily and visually the character array part he or she has failed to type or typed in error. Also, it is easy for the player to distinguish the character array part he or she would have trouble in typing among many kinds of character array parts he or she has typed during the typing game, thereby enhancing the player's desire to play the game again. Further, the lyrics of the musical composition used in the typing game is displayed upon completion of the typing game such that advertisement effects of the musical composition on people around the typing game machine are enhanced.

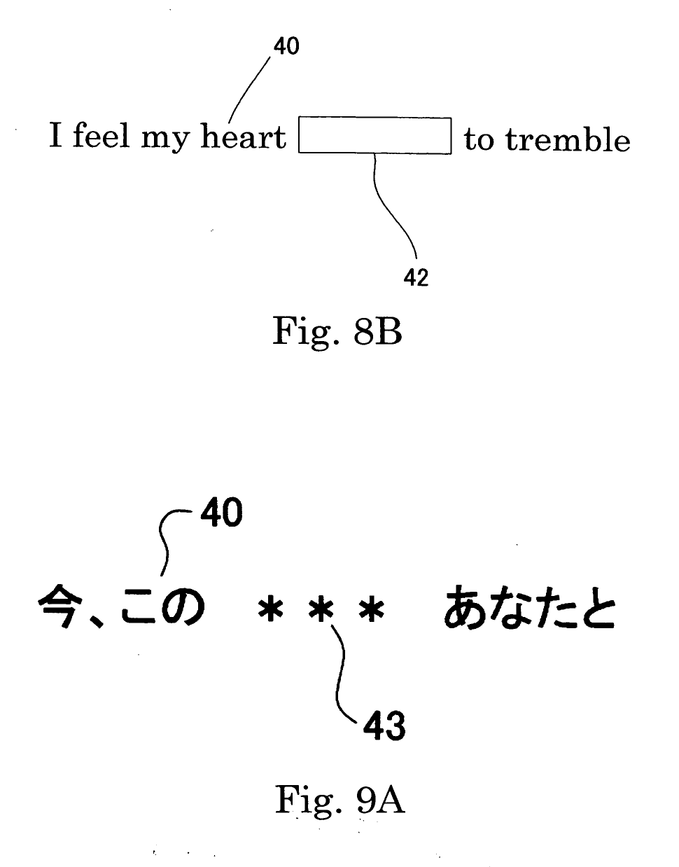

Now, the character array part the player failed to type correctly may not be displayed only in the manner that the underline part 41 replaces the character array, but also in another manner that the player can distinguish the incorrectly typed character part from the base character array part 40. FIGS. 8A to 10B shows the character array part of the lyrics displayed in various manners on the lyrics display result screen 35 in the typing game machine of other embodiments. FIGS. 8A, 9A and 10A shows examples of Japanese lyrics and FIGS. 8B, 9B and 10B shows examples of English lyrics.

For example, FIGS. 8A and 8B, the correctly typed character array part is displayed on the lyrics display result screen 35 as the base character array part 40. On the other hand, the incorrectly typed character array part is not displayed with characters having actually been typed on the lyrics display result screen 35, but is replaced with blank 42 (or rectangular mask 42) to appear as shown in FIGS. 8A and 8B. Therefore, the player can recognize easily and visually the character array part he or she has failed to type or typed in error.

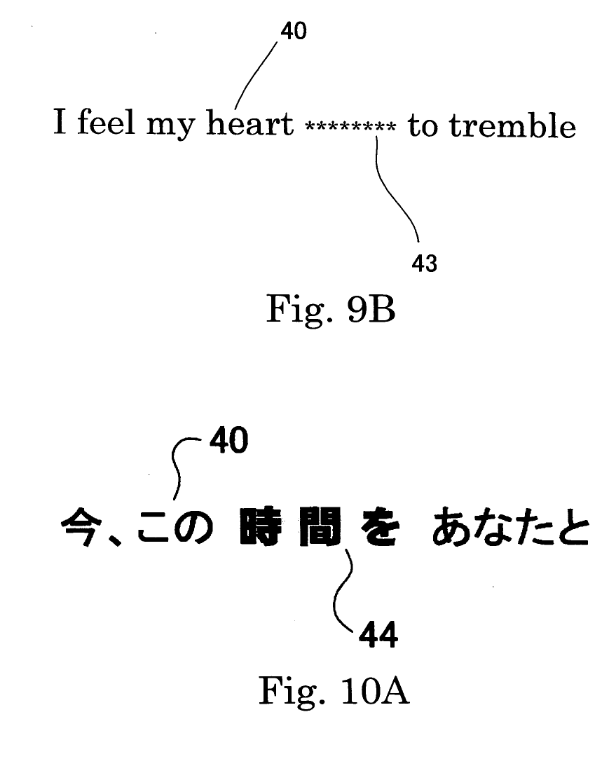

And as shown in FIGS. 9A and 9B, the correctly typed character array part of the character array displayed in the lyrics display part 22 on the main game screen 21 is displayed on the lyrics display result screen 35 as the base character array part 40. On the other hand, the incorrectly typed character array part is not displayed with characters having actually been typed on the lyrics display result screen 35, but is replaced with symbols “*” 43 to appear as shown in FIGS. 9A and 9B. Therefore, the player can recognize easily and visually the character array part he or she has failed to type or typed in error.

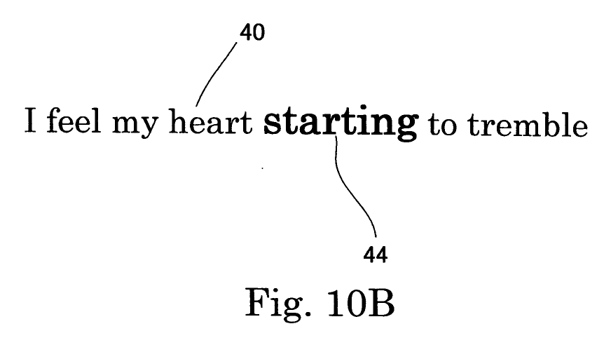

Further, as shown in FIGS. 10A and 10B, the correctly typed character array part of the character array displayed in the lyrics display part 22 on the main game screen 21 is displayed on the lyrics display result screen 35 as the base character array part 40. On the other hand, the incorrectly typed character array part is not displayed with characters having actually been typed on the lyrics display result screen 35, but is displayed as an other color character array part 44 being composed of characters in another color than the color of the characters of the base character array part 40 (e.g., the other color character array part 44 in red as opposed the base character array part 40 in white). Therefore, the player can recognize easily and visually the character array part he or she has failed to type or typed in error with the help of color difference. Now, without changing colors of the characters, fonts (e.g., mincho font and Gothic font) and character sizes (e.g., 24 points and 32 points) may be utilized to change the display manner to distinguish the correctly typed character part and the incorrectly typed character part.

In this embodiment, the first liquid crystal display 3 displays the game result screen 30 while the second liquid crystal display 4 displays the lyrics display result screen 35. However, the first liquid crystal display 3 or the second liquid crystal display 4 may display both the game result and the lyrics of the musical composition at the same time.

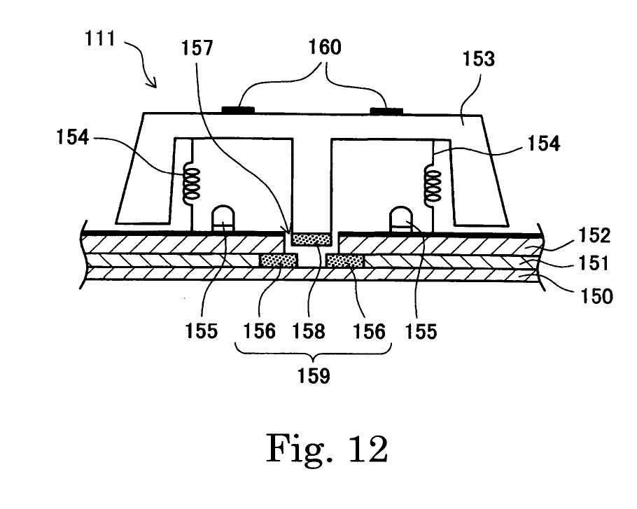

Then, an explanation will be made for the keyboard 6 provided in the typing game machine 1 in reference to FIGS. 11A to 12. FIG. 11A is a plain view showing the keyboard provided in the typing game machine of this embodiment. FIGS. 11B and 11C are plan views of other kinds of keyboards, which may be employed in the typing game machine of this embodiment. FIG. 12 is a schematic cross sectional view showing the cross section of any one of a plurality of keys provided on the keyboard.

As shown in FIG. 1A, the keyboard 6 is a Japanese language 108 keyboard in which a plurality of character enter keys 111 for entering “alphabetic letters (A to Z),” “Japanese syllabary (‘a’ to ‘n’),” “numerals (0 to 9)” and “symbols (period and comma)” as well as function keys 115 such as an enter key 112, a shift key 113 and cursor keys 114 are individually arranged. Then, while a game is in progress, a player types the character enter keys 111 corresponding to characters, symbols, numerals and others, thereby entering characters to advance the game. Further, prior to starting the game or after completion of the game, the player gives instructions to select and decide a musical composition for the game or the degree of difficulty or to start and execute the game by operating the function key 115. Light-emitting diodes are provided inside each of the keys on the keyboard 6, and the keys are constituted so as to emit light in various modes according to control signals provided from a CPU 51.

In this instance, an explanation will be made for the inner structure of the keyboard 6 by referring to FIG. 12. The keys arranged on the keyboard 6 are all identical in inner structure. Hereinafter, an explanation will be made by referring to the inner structure of one character enter key 111 among a plurality of keys arranged on the keyboard 6, and an explanation will be omitted for the rest of the character enter keys 111 and the function keys 115.

As shown in FIG. 12, the character enter key 111 is basically composed of a base plate 150, a switch circuit plate 151, a light-emitting circuit plate 152, a key top 153, an energizing mechanism 154, a full-color LED 155 and others.

In this respect, the switch circuit plate 151 arranged on the base plate 150 is provided with a pair of electrodes 156 disposed approximately below the center of the key top 153.

Further, the light-emitting circuit plate 152 attached on the switch circuit plate 151 is provided with an opening 157 for exposing a pair of electrodes 156, and the full-color LED 155 capable of lighting in a full color is provided around the opening 157.

The energizing mechanism 154 is provided between the light-emitting circuit plate 152 and the key top 153, and applies energy on key top 153 to the opposite side of the switch circuit plate 151 by the energizing mechanism 154. In addition, an electrode 158 is projected toward the switch circuit plate 151 approximately at the center of the key top 153. Since the electrode 158 projected on the key top 153 can be brought into contact with the a pair of electrodes 156 provided on the switch circuit plate 151 by depressing the key top 153, depression of the key top 153 can be transmitted as an electrical signal flowing through the switch circuit plate 151. That is, a key switch 159 is composed of these three electrodes 156 and 158.

The energizing mechanism 154 may be composed of an elastic body alone or with an elastic body and cross-linking mechanism. There is no particular restriction on the constitution.

Further, the key top 153 is formed with translucent materials (for example, transparent acryl and transparent plastic materials), and key information 160 such as characters, numerals and symbols are printed in black at the flat part on the surface. The surface of the light-emitting circuit plate 152 facing the key top 153 is also printed in black.

While the full color LED 155 is not lit, the translucent key top 153 is reflected in black which is a surface color of the light-emitting circuit plate 152. It is, therefore, difficult to recognize the key information 160 which is printed in black on the key top 153 reflected in black.

On the other hand while the full color LED 155 is lit, the translucent key top 153 is reflected in a lighting color derived from the full color LED 155. Therefore, the key information 160 which is printed in black on the key top 153 reflected in the lighting color can be easily recognized.

Then, in the keyboard 6a key switch 159 inside each key is connected to a signal sending circuit (not illustrated). The signal sending circuit is connected via an interface unit 52 to be described later (hereinafter, abbreviated as I/O) to the CPU 51 of the typing game machine 1. Therefore, when an electric signal from the key switch 159 depressed by the key is sent via the signal sending circuit to the CPU 51, it is possible to identify the type of depressed key. The signal sending circuit is loaded on the switch circuit plate 151.

Further, in the keyboard 6, the full color LED 155 inside the key is connected to an emission control circuit 62. The emission control circuit 62 is connected to the CPU 51 via the I/O 52 (refer to FIG. 14). It is, therefore, possible to light on the full color LED 155 inside the key in a color specified by the CPU 51 via the emission control circuit 62. To be more specific, where it is determined that key entry is made and determined that a correct typing is performed while a typing game is in progress in typing game machine 1 of this embodiment, the character enter key 111 is emitted in a blue color upon depression. Where it is determined that key entry is made and determined that an erroneous typing is performed, the character enter key 111 is emitted in a red color upon depression and a correct key to be entered is emitted in a green light. Further, where no key entry is made, only a correct key to be entered is emitted in a green color.

As shown in FIG. 13, the typing game machine 1 of this embodiment is connected to a server 80 via a network N which can bi-directionally communicate such as the Internet. Then, the typing game machine 1 is able to update music data stored in the HDD 55 of the gaming machine 1 on the basis of the data sent from the data server 80 (refer to FIG. 14).

It is, therefore, possible to change types of musical composition which can be played in the typing game machine 1 by updating the music data. It is also possible to easily update the data by comprehensively controlling typing game machines installed at game shops.

Next, an explanation will be made for the constitution related to a control system of the typing game machine 1 by referring FIG. 14. FIG. 14 is a block diagram graphically showing the control system of the typing game machine of the embodiment 1.

As shown in FIG. 14, the control system of the typing game machine 1 is composed of a CPU 51 which controls game processing operations and others in the typing game machine 1, a ROM 53 and a RAM 54 connected to the CPU 51 and a peripheral unit (actuator) electrically connected to the CUP 51.

The CPU 51 is a central processing unit which conducts computing processes according to various commands. The I/O 52 is a part which electrically connects the CPU 51 with the liquid crystal display 3, the second liquid crystal display 4, the keyboard 6, the external illumination LEDs 7, the speakers 8 and others directly or indirectly.

The ROM 53 is a non-volatile read-only memory which accommodates computing programs and others for conducting a flow chart to be described later.

Further, the RAM 54 is a memory for temporarily storing various data computed at the CPU 51 and also storing the number of typing errors made by the player in the current typing game, acquired scores, acquired points, and true/false character array distinction information to distinguish the character array the player has failed to type correctly among the character array (lyrics of the musical composition) having been displayed during the typing game and the like. In addition, among a plurality of music data stored in the HDD 55 to be described later, lyrics data of the music data used in the current typing game is divided into each phrase and temporarily stored in the RAM 54.

The HDD 55 is a storage unit which accommodates music data used when a typing game is conducted in the typing game machine 1. In this instance, the music data includes screen image data, performance data, audio data, lyrics data, determination criterion data, LED emission pattern data, keyboard emission pattern data and time-limit data, which is stored in individual storage areas of a music data storage area 56 formed inside the HDD 55 (refer to FIG. 15).

Further, the music data is stored in plurality (up to 8 in this embodiment) in the music data storage area 56. As described previously, individual music data stored on the basis of data sent from a data server 80 is updated, whenever necessary. Then, types of music titles displayed on the music selection screen 15 (refer to FIG. 2) are changed on the basis of types of music data stored in the data music data storage area 56, and a typing game is conducted according to the music data corresponding to musical compositions selected by the music selection screen 15 (refer to FIGS. 3A to 4C).

In this instance, a more detailed explanation will be made by referring to FIG. 15 for the music data storage area 56 provided in the HDD 55. FIG. 15 is a drawing for graphically explaining the music data storage area.

As shown in FIG. 15, the music data storage area 56 of the typing game machine 1 in this embodiment is composed of a plurality of storage areas (a first storage area to an eighth storage area in this embodiment) corresponding to the number of storable music data (8 musical compositions in this embodiment). Each storage area is provided with a screen image data storage area 56A, a performance data storage area 56B, an audio data storage area 56C, a lyrics data storage area 56D, a determination criterion data storage area 56E, an LED emitting pattern data storage area 56F, keyboard emitting pattern data storage area 56G and a time-limit data storage area 56H.

Hereinafter, an explanation will be made for each storage area. The screen image data storage area 56A is a storage area which stores screen image data on a PV screen image 20 of an artist displayed on the second liquid crystal display 4, among the music data (refer to FIGS. 3A and 4A).

The performance data storage area 56B is a storage area which stores performance data on instrumental accompaniment output from the speakers 8 among the music data.

Further, the audio data storage area 56C is a storage area which stores audio data on a singing voice sung by an artist output from the speakers 8 among the music data.

In addition, the lyrics data storage area 56D is a storage area which stores lyrics data on document data of musical composition lyrics among the music data. Then, as described previously, when the typing game is conducted, lyrics prepared for each one phrase are displayed on the first liquid crystal display 3 (refer to FIGS. 3B and 4B). And the whole phrases are displayed on the second liquid crystal display 4 at the end of the typing game (refer to FIG. 5A).

Then, the determination criterion data storage area 56E is a storage area which stores determination criterion data on criteria for whether or not a player types characters correctly and at a correct timing while a typing game is in progress, among the music data. The CPU 51 adds the number of typing errors, scores, points and others on the basis of the stored determination criterion data and operation signals from the keyboard 6.

The LED emitting pattern data storage area 56F and the keyboard emitting pattern data storage area 56G are storage areas which store LED emitting pattern data for emitting the emission lights 7 and keyboard emitting pattern data for emitting a full color LED 155 installed inside the key, among the music data. In the typing game machine 1 of the embodiment 1, these eight emission lights 7 are controlled so as to provide individual light-emitting modes (for example, emission color, lighting on and lighting off) by an emission control circuit 62 to be described later while a typing game is in progress on the basis of the stored LED emitting pattern data. Further, the full color LED 155 provided inside the key is controlled so as to provide individual light-emitting modes (for example, emission color, lighting on and lighting off) by the emission control circuit 62 to be described later while a typing game is in progress on the basis of the stored keyboard emitting pattern data. Light-emitting patterns of the full color LED 155 include a light-emitting pattern for a beginner of a typing game in which key entry is assisted by lighting on the key to be entered in sequence in an illumination color different from that of a whole of the keyboard 6 and a pattern in which all the keys arranged on the keyboard 6 are changed in illumination color in accordance with an image of the musical composition concerned.

The time-limit data storage area 56H is a storage area which stores tine-limit data on the expiration date of music data among the music data, and the time-limit data includes data of two dates, namely, the date when the music data is usable (use commencement date) and the date when the music data becomes unusable (use completion date). The time-limit data becomes used in controlling the expiration date of individual music data, together with a timer 58 (refer to FIG. 14), and the CPU 51 controls so that no typing game can be played by using the music data, the date of which is expired.

FIG. 4C shows an example with English lyrics. Since the configuration is similar to that in FIG. 4B, a duplicated explanation is omitted. The lyrics data storage area 56D as shown in FIG. 15 is a storage area which stores the lyrics data on document data of musical composition lyrics among the music data. Then, as described previously, when a typing game is conducted, lyrics prepared for each one phrase are displayed on the first liquid crystal display 3 (refer to FIGS. 3B, 3C, 4B and 4C).

In this instance, an explanation will be made for the control system of the typing game machine 1 by referring to FIG. 14 again.

The game communications means 57 is a unit in which signals sent from the typing game machine 1 are converted to transmittable signals according to communications forms such as telephone lines and LAN cables, and sent to a server 80, signals sent from the server 80 are received and converted again to signals that can be read by the typing game machine 1. This unit is connected via the network N which can bi-directionally communicate such as a server communications means 81 of the server 80 and the Internet (refer to FIG. 13).

Further, a timer 58 having a function of the calendar is connected to the CPU 51. Information on the timer 58 is sent to the CPU 51, and the CPU 51 controls the expiration date of stored music data by referring to the information on the timer 58 and the time-limit data stored in the time-limit data storage area 56H of the HDD 55.

Further, a display control circuit 60 is connected to the CPU 51 via the I/O 52 and controls the contents displayed by the first liquid crystal display 3 and the second liquid crystal display 4, according to computing processing results of the CPU 51. In this instance, the display control circuit 60 is composed of a program ROM, an image ROM, an image control CPU, a work RAM, a VDP (video display processor), a video ROM and others. Then, the program ROM accommodates image control programs on display by the first liquid crystal display 3 and the second liquid crystal display 4 as well as various selection tables. Further, the image ROM accommodates dot data for forming various images, for example, the music selection screen 15 (refer to FIG. 2), the main game screen 21 (refer to FIGS. 3B and 4B), the game result screen 30 (refer to FIG. 5B), the lyrics display result screen 35 (refer to FIG. 5A), the game end screen 45 (refer to FIG. 6) displayed on the first liquid crystal display 3 and the like.

Then, the image control CPU decides an image displayed on the first liquid crystal display 3 and the second liquid crystal display 4 from the dot data stored in advance in the image ROM according to the image control program in advance stored in the program ROM on the basis of parameters set by the CPU 51. Additionally, the VDP forms an image according to display contents determined by the image control CPU, outputting the image on the first liquid crystal display 3 or the second liquid crystal display 4.

Therefore, for example, in a standby state, demonstration screens including PV of any given musical composition, advertisement and a ranking list are displayed. After coins are inserted into the coin insertion slot 9, the music selection screen 15 is displayed on the first liquid crystal display 3 (refer to FIG. 2). Then, when a typing game is started and conducted in the typing game machine 1, control is given, for example, lyrics data which constitute music data are displayed for each phase on the first liquid crystal display 3, and the character array 23A already typed by a player on the basis of the entered result of the keyboard 6 is displayed at the Roman character display part 23. On the other hand, the PV which is screen image data constituting music data is displayed on the second liquid crystal display 4. At the end of the typing game, the game result screen 30 (refer to FIG. 5B) is displayed on the first liquid crystal display 3 and the lyrics display result screen 35 (refer to FIGS. 5A and 5C) is scroll-displayed.

A sound control circuit 61 is connected to the CPU 51 via the I/O 52, and also to the speakers 8. Then, when a typing game is conducted and music data stored in a music data storage area 56 of the HDD 55 is read out, performance data and audio data constituting the music data are converted to sound signals by the sound control circuit 61 and output from the speakers 8.

Then, an emission control circuit 62 is connected to the CPU 51 via the I/O 52 and also connected to the emission lights 7 and the full color LED 155 disposed inside the key (refer to FIG. 12). When music data stored in the music data storage area 56 of the HDD 55 are read out by the CPU 51, the emission control circuit 62 controls light emitting modes of the emission lights 7 and the full color LED 155 on the basis of LED emitting pattern data and keyboard emitting pattern data constituting the music data.

Further, the CPU 51 is connected to the keyboard 6. A key switch 159 provided inside each key of the keyboard 6 sends the fact that the key top 153 is depressed as an electrical signal flowing through the switch circuit plate 151. The CPU 51 controls to execute various operations corresponding to each key on the basis of a switch signal output from each of the key switch 159 upon depression of the keys.

The coin sensor 63 is a sensor for detecting coins (for example, 100 yen coins) used as a value in conducting a typing game in the typing game machine 1. The coin sensor 63 is disposed inside a coin insertion slot 9 and connected to the CPU 51 via the I/C 52. Therefore, the coin sensor 63 sends a coin insertion signal to the CPU 51 on the basis of coins inserted into the coin insertion slot 9. Then, the CPU 51 detects the coin insertion signal corresponding to a predetermined amount (for example, 200 yen), thereby allowing to play the typing game.

Further, the card sensor 64 is also a sensor for detecting whether an IC card is inserted into the card insertion slot 10 or not, and the card reader/writer 65 is a unit for reading and writing an IC tag disposed on the IC card. The card sensor 64 and the card reader/writer 65 are disposed inside the card insertion slot 10 and connected to the CPU 51 via the I/O 52. Then, when the IC card is detected by the card sensor 64 and a predetermined operation is conducted, the card reader/writer 65 reads the result of a typing game from the IC tag (S3 in FIG. 16). When the typing game is completed, new game results (acquired scores and points) are written into the IC tag (S9 in FIG. 16).

Then, an explanation will be made for main processing programs carried out in the typing game machine 1 having the above-described constitution by referring to FIG. 16. FIG. 16 is a flow chart showing the main processing programs for the typing game machine 1 of this embodiment. Individual programs of the flow charts given in FIGS. 16 to 19 are stored in the ROM 53 and the RAM 54 provided in the typing game machine 1 and carried out by the CPU 51.

As shown in FIG. 16, first, the CPU 51 detects whether an IC card is inserted into the card insertion slot 10 or not on the basis of a detection signal sent from the card sensor 64. Then, where it is determined that the IC card is inserted thereinto (S1: Yes), a determination is made in S2 for whether confirmation of data contents is requested by a player or not. On the other hand where it is determined that no IC card is inserted (S1: No), the typing game machine 1 proceeds to S4.

In the typing game machine 1 of this embodiment, when a shift key 113 of the keyboard 6 is depressed before coins are inserted and in a state that the IC card owned by a player is kept inserted into the card insertion slot 10, a list of game results stored in the IC card (scores, points and others so far acquired by the player) is displayed on the first liquid crystal display 3, from which the player is able to confirm the contents.

Therefore, in S2, a determination is made for whether the shift key 113 is depressed or not on the basis of an operation signal from the keyboard 6 and it is determined that the shift key 113 is depressed (S2: Yes), the card reader/writer 65 reads IC tag data built in the IC card, thereby displaying the list of game results on the first liquid crystal display 3 on the basis of the thus read data (S3).

Further, a start reception process is carried out in S4. To be more specific, in the start reception process, a determination is made for whether coins (100 yen coins and others) are inserted into the coin insertion slot 9 or not in a predetermined amount (200 yen in this embodiment). Until such insertion is made, a standby state is kept in which a game screen for demonstration play and a demonstration screen for PV of any given musical composition, advertisement and list of ranking data are displayed. Further, in the typing game machine 1 of this embodiment, when coins are inserted into the coin insertion slot 9, the coin sensor 63 detects the fact and sends a coin detection signal to the CPU 51, by which the CPU 51 can determine that coins have been inserted by a player.

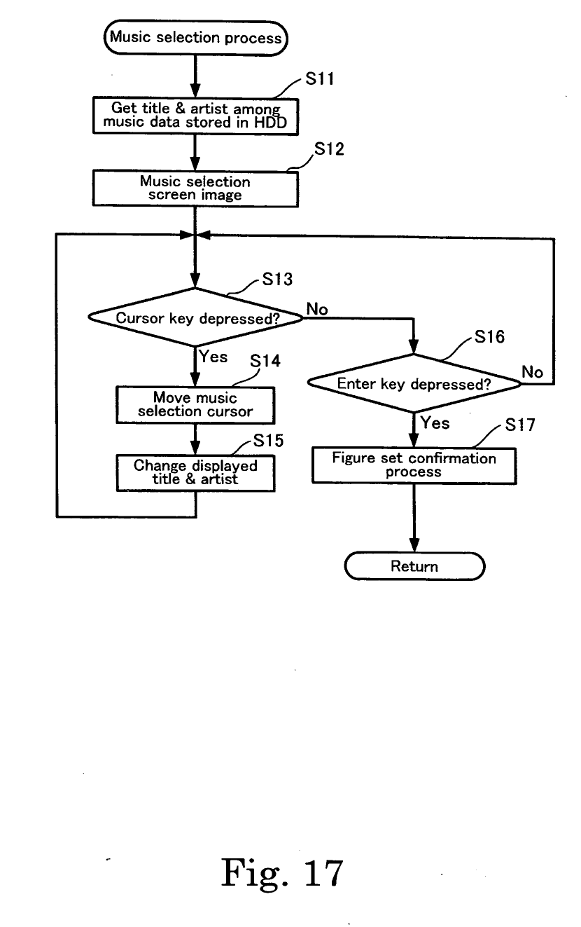

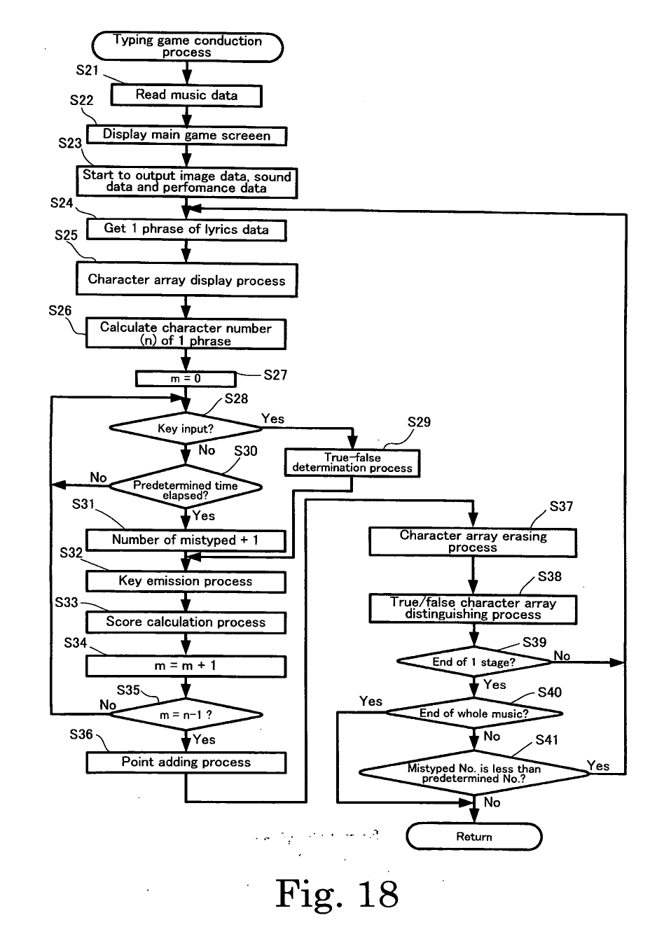

Then, in S5, a musical composition selection process is carried out as shown in FIG. 17. In the musical composition selection process, as described later, the music selection screen 15 (refer to FIG. 2) is displayed on the first liquid crystal display 3 according to a type of music data stored in the music data storage area 56 of the HDD 55, thereby setting the musical composition to be used in the current game.

Then, in S6, a typing game conduction process is carried out according to a musical composition set in the S5, as shown in FIG. 18. As is explained later, in the typing game conduction process, the musical composition is performed and scores, points and others are added on the basis of typing results of the keyboard 6 to continue a typing game until predetermined completion requirements are met.

Thereafter, when the typing game conduction process is completed, a game result display process is carried out (S7). In the game result display process, as described later, the game result screen 30 (refer to FIG. 5B) is displayed on the first liquid crystal display 3 based on the result of the typing game conduction process in S6 and the lyrics display result screen 35 (refer to FIG. 5A) is scroll-displayed. That is, the screen 35 will be scrolled up to show the whole lyrics.

Next, in S8, the CPU 51 makes a determination on whether an IC card is inserted into the card insertion slot 10 by referring to a detection signal from the card sensor 64. Further, where it is determined that the IC card is inserted (S8: Yes), in S9, the points and scores acquired in the current typing game and stored into the RAM 54 are individually written into an IC tag built-in the IC card by the card reader/writer 65. The thus written data can be referred to by the data content displaying process in the S3.

On the other hand where it is determined that no IC card is inserted (S8: No), the process is completed.

Further, an explanation will be made by referring to FIG. 17 for musical composition selection processing programs of the S5 carried out in the typing game machine 1. FIG. 17 is a flow chart of the musical composition selection processing programs of this embodiment. In the musical composition selection process, first, in S11, music titles and artist names of musical compositions (up to 8 in this embodiment) on stored music data are individually obtained from the music data storage area 56 of the HDD 55.

Then, the music selection screen 15 (refer to FIG. 2) is displayed on the first liquid crystal display 3 according to music titles and artist names of the musical compositions obtained in the S11 (S12). In the music selection screen 15, titles of musical composition obtained in the playable music title displaying part 16 are enlisted and displayed. Further, the music titles and artist names of musical compositions selected by the music selection cursor 17 are displayed respectively at the selected music title displaying part 18 and the selected artist name displaying part 19.

Further, in S13, a determination is made for whether the cursor key 114 is depressed or not. In this instance, whether the cursor key 114 is depressed or not is determined by referring to an operation signal sent from the keyboard 6. Where it is determined that the cursor key 114 is depressed (S13: Yes), a music selection cursor 17 displayed on the first liquid crystal display 3 is moved toward the depressed direction on the basis of the operation of the cursor key 114 (which key is depressed, of the left, right, up and down ones) (S14).

In addition, in S15, the display of the selected music title displaying part 18 and that of the selected artist name displaying part 19 are changed respectively to the music title and the artist name corresponding to the musical composition selected by the music selection cursor 17 moved in the S14. Thereafter, the typing game machine returns to a determination process in S13.

In contrast, where it is determined that the cursor key 114 is not depressed (S13: No), a determination is continuously made for whether the enter key 112 is depressed or not in S16. Then, where it is determined that the enter key 112 has been depressed (S16; Yes), the musical composition on which the music selection cursor 17 is now located is set to be a musical composition played in the current typing game (S17), and a typing game conduction process to be described later is started. On the other hand where it is determined that the enter key 112 has not been depressed (S16: No), the typing game machine again returns to the determination process in S13.

Then, an explanation will be made by referring to FIG. 18 for a typing game conduction process program carried out by the typing game machine 1 in the S6. FIG. 18 is a flow chart showing the typing game conduction process program for this embodiment.

In the typing game conduction process, first, the CPU 51 reads out music data corresponding to the musical composition selected by the musical composition selection process in the S5, among music data stored at each storage area (refer to FIG. 15) of the music data storage area 56 of the HDD 55 in S21. Then, in particular, lyrics data accommodated in the lyrics data storage area 56D are divided into each phrase and temporarily stored in the RAM 54.

Next, the main game screen (refer to FIGS. 3B and 4B) is displayed on the first liquid crystal display 3 in S22. At this moment, a character array is not displayed at the lyrics display part 22 or at the Roman character display part 23, and the points and score of the score displaying part 27 is displayed as “zero.”

In S23, the PV screen image 20 of the musical composition selected on the second liquid crystal display 4 is started to be displayed on the basis of the screen image data stored in the screen image data storage area 56A (refer to FIGS. 3A and 4A). Further, music for accompaniment is output on the basis of performance data stored in the performance data storage area 56B and voice is output on the basis of audio data stored in the audio data storage area 56C individually via the speakers 8, by which the musical composition is performed and the PV screen image 20 is reproduced accordingly.

Next, in S24, a part of lyrics equivalent to one phase of the lyrics data accommodated in the RAM 54 is obtained. The character array 22A corresponding to the thus obtained lyrics data is subjected to a character array display process to display the array 22A in the lyrics display part 22 of the main game screen 21 (S25). Thus, the first liquid crystal display 3 displays the main game screen 21 as the second liquid crystal display 4 displays the PV image 20 and the musical composition is performed (refer to FIGS. 3B, 3c, 4B and 4C).

Thereafter, in S26, the number of characters for one phrase, n, is calculated on the basis of the one-phrase lyrics data obtained in the S24 and zero is assigned to any given variable m accommodated in the RAM 54 (S27). In this instance, any given variable m is a variable used in entry determination for a character corresponding to each character constituting one phrase and a variable is added by one each time when an entry determination of one character is completed (S34). Therefore, in each entry determination process repeated in the following S28 to S35, when m=t (0≦t≦n−1), an entry determination is to be made for a character which is located at (t+1)^{th} on calculation from the first character of one phrase.

Further, in S28, a determination is made for whether key entry is made by the character enter key 111 or not, on the basis of an operation signal sent from the keyboard 6. Where it is determined that key entry has been made (S28; Yes), a determination is made for whether keys are correctly entered or not on the basis of types of keys depressed and the determination criterion data stored in the determination criterion data storage area 56E (S29). To be more specific, it is recognized as correct typing when a key corresponding to the character array 22A displayed at the lyrics display part 22 of the main game screen 21 (refer to FIGS. 3B and 4B) is depressed. Then, where it is determined that a key other than the corresponding key has been depressed, the number of typing errors is added by one. Thereafter, the typing game machine proceeds to S32.

On the other hand, where it is found that no key entry has been made (S28: No), a determination is made for whether a predetermined time on the basis of the information on a timer 58 (calculation is made after a character array corresponding to one phrase is displayed in relation to the main game screen 21 when the first character of one phrase is entered (S25), whereas calculation is made after a score calculation process when other characters are entered (S33)) has passed or not (S30). Then, where it is determined that a predetermined time has not passed (S30: No), the typing game machine returns to the process in S28.

In contrast, where the CPU 51 determines that a predetermined time has passed (S30: Yes), the number of typing errors in the current game accommodated in the RAM 54 is added by one, on the assumption that no key entry has been made by a player (S31).

Then, in S32, the light emitting process for a key is carried out on the basis of the full color LED 155 provided inside the keyboard 6. To be more specific, in the typing game machine 1 of this embodiment, where it is determined that key entry is made (S28: Yes) and a correct typing is also made, the depressed character enter key 111 is emitted in a blue color. Further, where it is determined that key entry is made (S28: Yes) and an erroneous typing is made at the same time, the depressed character enter key 111 is emitted in a red color and a correct key to be entered is emitted in a green color. Further, where no key entry is made (S28: No), a correct key to be entered is emitted in a green color.

Further, in S33, a score calculation process is carried out on the basis of the determination process in the S29 on whether keys are correctly entered or not. In the score calculation process, a score is added where it is determined that the score obtained by a player in the current game and accommodated in the RAM 54 is correctly typed by referring to the above determination process. Also, an additional score is added where it is determined that characters are typed at the same timing with the voice of the musical composition to be performed.

Thereafter, in S34, a variable m accommodated in the RAM 54 is read out to add “+1” and the variable is again accommodated. Then, in S35, a determination is made for whether a value of the variable m has reached n−1 or not, namely, whether all entry determinations for each character that forms one phrase have been completed.

Then, where it is determined that the value of the variable m does not reach n−1 (S35: No), the typing game machine again returns to S28, and an entry determination is made for a character located following position among the characters which form one phrase.

On the other hand where it is determined that the value of the variable m has reached n−1 (S35: Yes), it is deemed that all characters of one phrase have been completely entered. Therefore, in S36, a point adding process is carried out. In the point adding process, where it is determined that n characters constituting one phrase have been completely entered without any typing errors (including determination of typing errors due to passage of a predetermined time (S31)), one point is added.

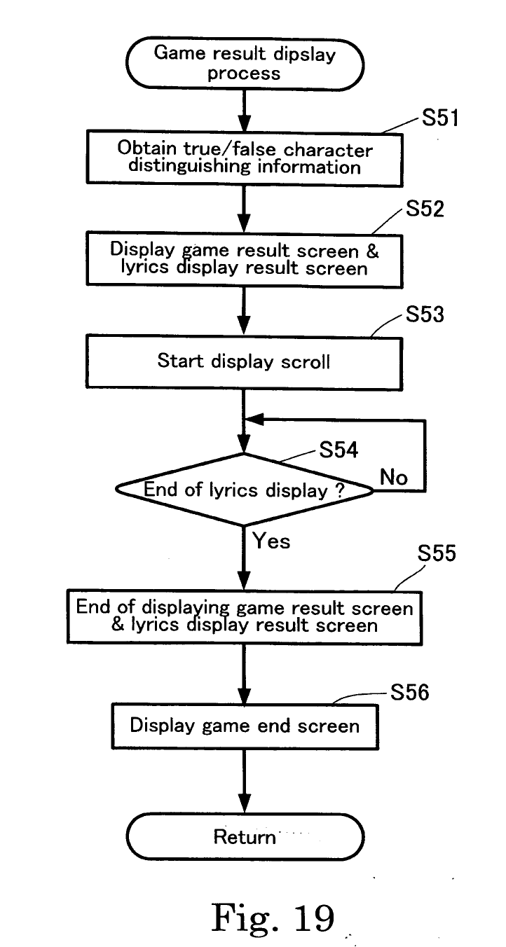

Then, the character array 22A having been displayed in the lyrics display part 22 on the main game screen 21 is erased in S37. After that, the true/false character process is conducted such that, in the character array constituting one phrase being displayed in the above S25 to S37, a character array part the player has typed correctly during the game (hereafter to be referred to as the correct character array part) and another character array part the player has failed to type correctly during the game (more specifically, the character array part having been mistyped during the game and having failed to be typed within the period of time that the character array is displayed, hereafter to be referred to as the incorrect character array part) are distinguishably stored in the RAM 54 (S38). Thus, character array parts are determined to be displayed on the lyrics display result screen 35 (refer to FIGS. 5A and 5C) in predetermined manners depending on the distinction through the true/false character array process (refer to S52 and S53 in FIG. 19). Here, the correctly typed character array part is determined to be the character array part, characters of which are typed correctly during displaying the corresponding character array 22A in the lyrics display part 22 (during the period of time between S25 and S37), irrespective of synchronization with the voice reproduction of the performed musical composition.

Further, in S39, a determination is made for whether or not an entry determination has been completed for a phrase of a stage corresponding to any tune number among a plurality of tune numbers constituting a musical composition (usually one musical composition is composed of one to three tune numbers). Then, where it is determined that an entry determination has not been completed for a whole phrase covering one stage (S38: No), the typing game machine returns to S24. Lyrics of a next phrase are obtained from the RAM 54 and the corresponding character array is displayed at the lyrics display part 22 on the main game screen 21.

In contrast, where it is determined that an entry determination has been completed for a whole phrase covering one stage (S39: Yes), a determination is continuously made for whether an entry determination has been completed for phrases covering a whole stage or not (all the tunes in a musical composition) (S40).

Then, where it is determined that a whole stage has been completed (S40: Yes), irrespective of any points owned by a player, the current typing game conduction process is completed, and the typing game machine proceeds to a game result displaying process in S7. On the other hand where it is determined that a whole stage has not been completed (S40: No), a determination is then made for whether the number of typing errors made so far by a player added in the S29 and S31 is less than a predetermined number of typing errors or not (S41). The typing game machine 1 of this embodiment is composed of a plurality of stages according to the number of tune numbers of reproduced musical compositions. In order to play a stage related to a next tune number at a time when one stage has been completed, the number of typing errors made so far from the start of a game must be less than a predetermined number of typing errors. (For example, the number of typing errors must be less than 20 times in order to continue to play a part of number 2 after a part of number 1, and the number must be less than 35 times in order to continue to play a part of number 3 after the part of number 2.)

Then, where it is determined that the number of typing errors made so far by a player added in the S29 and S31 is less than a predetermined number of typing errors (S41: Yes), the typing game machine returns to S24. Lyrics corresponding to the first phrase of the next tune number are obtained from the RAM 54, and the corresponding character array is displayed at the lyrics display part 22 on the main game screen 21. Then, an entry determination process is carried out similarly. On the other hand, where it is determined that the number of typing errors made by a player is more than a predetermined number of typing errors (S41: No), the typing game conduction process is completed, and the typing game machine proceeds to the game result displaying process in S7.

Next, an explanation will be made by referring to FIG. 19 for a game result display process program of the S7 executed in the typing game machine 1 of this embodiment. FIG. 19 is a flow chart of the game result display process program for this embodiment.

In the game result display process, the true/false character process information, which has been processed in the true/false character process of the S38, is first obtained from the RAM 54 in S51. Here, the true/false character process information comprises information of the character array constituting each phrase of the musical composition displayed in the above-described S25 to S37 wherein such character arrays are distinctly categorized as a whole or in fragments in either the correct character array part or the incorrect character array part.

Then, in S52, the game result screen 30 (refer to FIG. 5B) is displayed on the first liquid crystal display 3 and the lyrics display result screen 35 (refer to FIGS. 5A and 5C) is displayed on the second liquid crystal display 4. The game result screen 30 shows the number of typing errors made in this typing game stored in the RAM 54, the acquired points and acquired scores, and the name entry display part 34 to prompt the player to enter his or her name is displayed on the game result screen 30. Further, when the keyboard 6 is operated in this condition, inputted characters are displayed in the name entry display part 34 based on the operation signals. Then, when the acquired scores are more than the predetermined scores, the ranking data being stored in the RAM 54 is renewed.

On the other hand, on the lyrics display result screen 35, the lyrics of the musical composition performed during the typing game conduction process of the S6, that is, the character array 22A having been displayed in the lyrics display part 22 and the player has been urged to type. At this time, the character array parts categorized in the correct character array part are displayed as the base character array part 44. And the character array parts categorized in the incorrect character array part are replaced with the underline parts 41 such that the array parts are not displayed.

The, the lyrics display result screen 35 displayed on the second liquid crystal display 4 is scrolled up at a predetermined rate such that the whole lyrics are displayed in sequence from tune number 1. Here, when the game is over in the middle of the stage because the number of typing errors becomes higher than the predetermined number, the lyrics of the tune numbers which have not been reproduced are all replaced with the underline parts 41 and displayed (or non-displayed because they are not visible) as the screen is scrolled up (for example, when the number of typing errors exceeds the predetermined number at the end of the first stage, the game is over after the first stage and the lyrics of tune numbers 2 and higher are all replaced with the underline parts 41).

Next, in S54, it is determined whether the whole lyrics of the musical composition are scroll-displayed on the lyrics display result screen 35 or not. When it is determined that the whole lyrics have not displayed yet (S54: NO), the scroll-display is continued. On the other hand, when it is determined that the whole lyrics have been displayed (S54: YES), the program proceeds to S55.

In the S55, the lyrics display result screen 35 having been displayed on the second liquid crystal display 4 and the game result screen 30 having been displayed on the first liquid crystal display 3 are erased and the game end screen 45 (refer to FIG. 6) is displayed on the first liquid crystal display 3 (S56). In the game end screen 45, “Game Over” 46 is displayed and the player is notified that the current game ends completely. After that, the game result display process is completed and the program proceeds to the determination process of S8.

As explained above, in the typing game machine 1 of this embodiment, in the state that a typing game conduction process (S6) is started as coins are inserted into the coin insertion slot 9, the true/false determination of typing based on the typing result of the player is conducted (S29, S30), and for each phrase of the lyrics of the musical composition, character array parts are categorized in the correct character array part that has been correctly typed and the incorrect character array part that has not been correctly typed (S38). And the character array parts categorized in the correct character array part of the whole lyrics are displayed as the base character arrays 40 and the character array parts categorized in the incorrect character array part of the whole lyrics are replaced with the underline parts 41 and displayed (S52, S53) based on the categorized character array information at the end of the game. Therefore, the player can easily recognize visually the character array parts he or she has mistyped and failed to type. It may also become easy for the player to recognize the character array he or she has trouble in typing among many kinds of character array parts the player has typed during the typing game. Further, since the lyrics of the musical composition used in the typing game are displayed again upon completion of the game, advertisement effects on people around the typing game machine may be improved.

In the foregoing, Japanese lyrics are picked such that Roman character entry is explained by way of example. However, the lyrics may be in English or other languages. As mentioned above, FIG. 4C shows a case of English lyrics. In this instance, since English is a language space-delimited such that the space key may be included as one character to be typed or it is also possible to make the space key not counted in the typing game (it is the case with this embodiment).

The typing game machine 1 of this embodiment is provided with two liquid crystal displays, namely, the first liquid crystal display 3 and the second liquid crystal display 4. More particularly, a PV screen image 20 of the musical composition to be performed is displayed on the second liquid crystal display 4 disposed above the cabinet (S23) and a main game screen 21 displaying a character array corresponding to lyrics of the musical composition is displayed on the first liquid crystal display 3 disposed below the cabinet 2 in parallel therewith (S22, S24), thus making it possible to provide various typing games using contents displayed on two screens, in comparison with the use of a single liquid crystal display. Therefore, a player does not get bored with a typing game and given an increased willingness to play the game.

Further, the PV screen image 20 is displayed on an independent liquid crystal display, thereby making it possible to display an artist singing a song in tune with a musical composition and conduct a typing game in a warmed up ambience than would otherwise be realized conventionally. Therefore, a player does not get bored with the game.

The present invention is not limited to the above embodiments, but a variety of modifications may be made without departing from the spirit and scope of the invention.

For example, in the typing game machine of this embodiment, the game may proceed by typing the character array 22A corresponding to the one phrase of lyrics displayed in the lyrics display part 22, but it may be modified to allow the player to type just part of the one phrase of lyrics (e.g., one word) to proceed the game.

In this case, it may be preferable that the lyrics display result screen 35 displayed on the second liquid crystal display 4 at the end of the game shows distinguishably the character array the player is supposed to type and the character array the player does not have to type, and also distinguishably the character array the player has typed correctly and the character array the player has failed to type correctly.

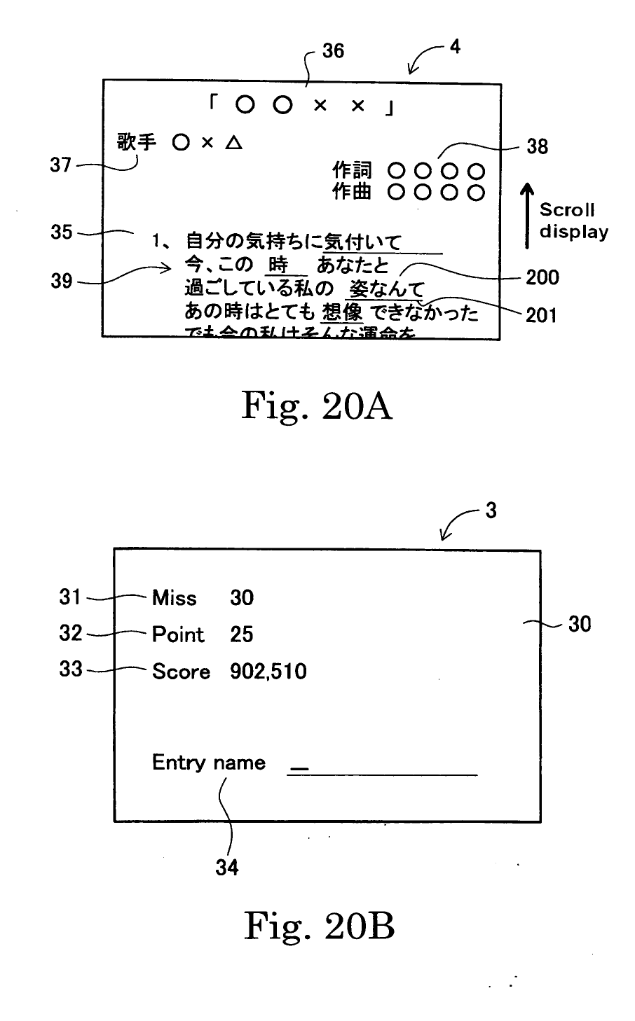

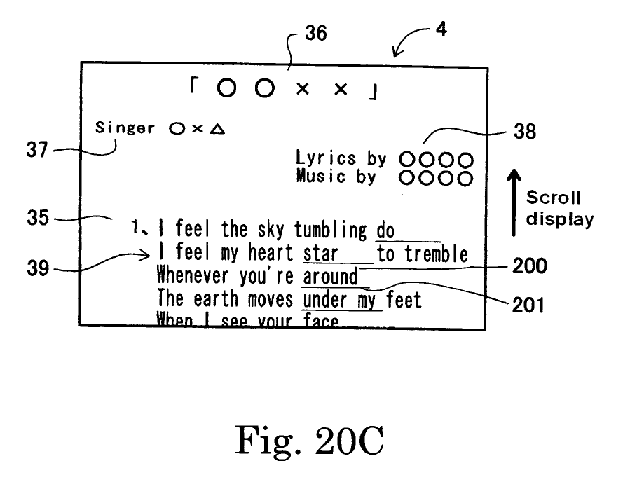

FIGS. 20A and 20B show respective contents displayed on the first liquid crystal display 3 and the second liquid crystal display 4 at the end of typing game according to one of the other embodiments described above.

Here, the lyrics display result screen 35 displayed on the second liquid crystal display 4 according to this embodiment is now explained. The lyrics display result screen 35 shows the character array 200 with the underline 201 which the player is supposed to type, wherein the character array 200 is composed of a part (e.g., one word) of one phrase of lyrics among the lyrics displayed in the lyrics result display part 39. And characters of the character array 200 displayed with the underline are displayed if such characters are typed correctly as a result of the game.

For example, in the first phrase shown in FIG. 20A, it is indicated that only “kiduiteita” part with the underline 201 of the one phrase of “jibunnokimochinikiduiteita” is the character array part that the player should type. However, only “kiduite” of “kiduiteita” is displayed such that it is indicated that “ita” part has not been typed correctly by the player during the game.

Similarly, in the second phrase shown in FIG. 20A, it is indicated that only “jikanwo” part with the underline 201 of the one phrase of “ima, konojikannwoanatato” is the character array part that the player should type. However, only “ji” of “jikanwo” is displayed such that it is indicated that “kanwo” part has not been typed correctly by the player during the game.

In the third phrase shown in FIG. 20A, it is indicated that only “sugatanante” part with the underline 201 of the one phrase of “sugoshiteiruwatashinosugatanante” is the character array part that the player should type. Since all characters necessary for typing are displayed, it is indicated that they have been typed correctly.

And, in the fourth phrase shown in FIG. 20A, it is indicated that only “souzou” part with the underline 201 of the one phrase of “anotokihatotemosouzoudekinakatta” is the character array part that the player should type. Since all characters necessary for typing are displayed, it is indicated that they have been typed correctly.

FIG. 20C shows another embodiment with English lyrics and is equivalent to FIG. 20A except for the Japanese lyrics. It shows the contents displayed on the second liquid crystal display 4 at the end of the typing game and the duplicated explanation will be omitted since the configuration is the same as shown in FIG. 20A.

Here, in the first phrase shown in FIG. 20C, it is indicated that only “down” part with the underline 201 of the one phrase of “I feel the sky tumbling down” is the character array part that the player should type. However, only “do” of “down” is displayed such that it is indicated that “wn” part has not been typed correctly by the player during the game.

Similarly, in the second phrase shown in FIG. 20C, it is indicated that only “starting” part with the underline 201 of the one phrase of “I feel my heart starting to tremble” is the character array part that the player should type. However, only “star” of “starting” is displayed such that it is indicated that “ting” part has not been typed correctly by the player during the game.

In the third phrase shown in FIG. 20C, it is indicated that only “around” part with the underline 201 of the one phrase of “Whenever you're around” is the character array part that the player should type. Since all characters necessary for typing are displayed, it is indicated that they have been typed correctly.

And, in the fourth phrase shown in FIG. 20C, it is indicated that only “under my” part with the underline 201 of the one phrase of “The earth moves under my feet” is the character array part that the player should type. Since all characters necessary for typing are displayed, it is indicated that they have been typed correctly.

Therefore, the player can recognize distinctly the character array part of the lyrics of the musical composition he or she is supposed to type in this game and distinguish character array parts he or she has typed correctly from other character array parts he or she has failed to type correctly by referring to the lyrics display result screen 35 at the end of game.

Also, in the typing game machine 1 of this embodiment, the lyrics display result screen 35 shows the lyrics by scrolling the screen up, but it may be modified to show part of the lyrics by one bar (or measure) or by one tune number of the musical composition, or the whole lyrics in one screen at the same time.

Further, the typing game machine 1 of this embodiment may be connected to the server 80 via the network N capable of the two-way communication such as the internet and the music data stored in the HDD 55 (refer to FIG. 15) of the typing game machine 1 may be renewed based on the transmitted data from the server 80. The system may be modified to allow the music data to be renewed independently from the server 80.

Further, as an embodied typing game machine according to the present invention, the above described cabinet-type typing game machine 1 which may be installed in the arcade or the like is explained by way of example. However, this invention may apply to a personal computer (PC) in which the software is installed as the typing game machine. And this invention may apply to the typing game software for the house-use game machine, which may be distributed by a medium such as cartridge and CD-ROM. Further, the typing game may be stored in the house-use game machine.

By way of example, there may be also provided a typing game machine (e.g., typing game machine 1) comprising: image display means (e.g., first liquid crystal display 3 and second liquid crystal display 4) for displaying a predetermined image relating to a game; input means (e.g., keyboard 6) including a plurality of arranged keys corresponding to a plurality of characters; display control means (e.g., CPU 51 and display control circuit 60) for controlling the image display means; true/false determination means (e.g., CPU 51, S29) for determining whether a character array inputted from the input means matches a predetermined character array (e.g., a character array 22A); determination result storage means (e.g., RAM 54) for storing determination result by the true/false determination means; and game control means (e.g., CPU 51) for controlling the game based on the determination result stored in the determination result storage means. Here, the display control means comprises: result display means (e.g., CPU 51, display control circuit 60, S52) for displaying a game result screen (e.g., game result screen 30) upon completion of the game based on the determination result stored in the determination result storage means; and determined character array display means (e.g., CPU 51, display control circuit 60, S52, S53) for displaying the predetermined character array having been referred to as a determination reference of the true/false determination means in the game having been completed when the result display means displays the game result screen. And the determined character array display means displays a correct character array part of the predetermined character array in a manner (e.g., in a color) and an incorrect character array part of the predetermined character array in another manner (e.g., in another color), the correct character array part comprising a character array having been inputted from the input means and determined to match the predetermined character array by the true/false determination means, and the incorrect character array part comprising a character array having been inputted from the input means and determined not to match the predetermined character array.

In such a typing game machine, the determined character array display means (e.g., CPU 51, display control circuit 60, S52, S53) may display the correct character array part and the incorrect character array part in different colors (e.g., the correct character array part in white as opposed to the incorrect character array part in red).

Also, such a typing game machine may comprise: image display means (e.g., first liquid crystal display 3 and second liquid crystal display 4) for displaying a predetermined image relating to a game; input means (e.g., a keyboard 6) including a plurality of arranged keys corresponding to a plurality of characters; display control means (e.g., CPU 51, display control circuit 60) for controlling the image display means; true/false determination means (e.g., CPU 51, S29) for determining whether a character array inputted from the input means matches a predetermined character array (e.g., character array 22A); determination result storage means (e.g., RAM 54) for storing determination result by the true/false determination means; and game control means (e.g., CPU 51) for controlling the game based on the determination result stored in the determination result storage means. In the typing game machine (e.g., typing game machine 1), the display control means comprises: result display means (e.g., CPU 51, display control circuit 60, S52) for displaying a game result screen (e.g., game result screen 30) upon completion of the game based on the determination result stored in the determination result storage means; determined character array display means (e.g., CPU 51, display control circuit 60, S52, S53) for displaying the predetermined character array having been referred to as a determination reference of the true/false determination means in the game having been completed when the result display means displays the game result screen; and character array non-display means (e.g., CPU 51, display control circuit 60, S52, S53) for hiding an incorrect character array part of the predetermined character array, the incorrect character array part comprising a character array having been inputted from the input means and determined not to match the predetermined character array by the true/false determination means.

In such a typing game machine, the display control means (e.g., CPU 51, display control circuit 60) comprises a replacement display means (e.g., CPU 51, display control circuit 60, S52, S53) for displaying a predetermined symbol (e.g., underlined part 41, blank 42, symbol ‘*’ 43) substituting the incorrect character array part hidden by the character array non-display means (e.g., CPU 51, display control circuit 60, S52, S53).

Also, the above-described typing game machine may comprise: music data storage means (e.g., HDD 55) for storing music data; and music processing means (e.g., CPU 51, music control circuit 61) for performing music at a predetermined tempo and outputting a voice based on the music data stored in the music data storage means, wherein the voice outputted by the music processing means relates to the predetermined character array (e.g., character array 22A).

In the above-described typing game machine, a game result screen is displayed based on the true/false determination result of the typing upon completion of the game and the predetermined character array which has been referred to as the determination reference of the true/false determination in the completed game may be displayed as the correct character array part and the incorrect character array part are displayed distinguishably in different manners. Thus, the player can recognize visually character array part which the player has inputted in error and failed to type. Also, it is not difficult to distinguish the character array part the player has had trouble in typing among a long character array the player is supposed to type in the typing game. Therefore, it is possible to enhance the player's desire to play the game again. Further, the character array having been used in the typing game can be displayed again upon completion of the game. Thus, the advertisement effect about the game on other potential players surrounding the typing game machine can be enhanced.

Further, in the typing game machine, the correct character array part and the incorrect character array part may be displayed in different colors. Thus, the player can recognize visually the character array part the player has inputted in error and failed to type by the color difference.

Further, in the typing game machine, the game result screen may be displayed based on the true/false determination result upon completion of the game and the incorrect character array part can be non-displayed (hidden) as the predetermined character array having been referred to as the true/false determination reference in the completed game. Therefore, it may be easy for the player to recognize visually the character array part the player has inputted in error and failed to type. And it may be easy for the player to distinguish the character array the player himself has trouble in typing among the long character array the player is supposed to input during the game such that the player's desire to play the game gain may be enhanced. Also, the game may appeal to the potential players surrounding the typing game machine by displaying the character array used in the typing game upon completion of the game.

Also, in the typing game machine, a predetermined symbol may be displayed over the incorrect character array having been non-displayed (or hidden). Therefore, the player can recognize visually the character array part the player has inputted in error or failed to type with ease.

Further, the typing game machine may output a voice and music at a specified tempo based on the stored music data and true/false determination may be conducted according to the agreement between the typed character array and that relating to the outputted voice.

What is claimed is:

1. A typing game machine comprising:
a display device; and
an input device,
wherein the typing game machine performs a game that provides higher evaluation for higher matching rate between a predetermined character array and a character array inputted from the input device in accordance with a game image displayed on the display device by comparing respective characters constituting the character arrays,
wherein the predetermined character array is displayed on the display device, and
wherein a correct character array part and an incorrect character array part of the predetermined character array are displayed in different manners, the correct character array part comprising a character array having been inputted from the input device and determined to match the predetermined character array, and the incorrect character array part comprising a character array having been inputted from the input device and determined not to match the predetermined character array.

2. The typing game machine according to claim 1, wherein the correct character array part and the incorrect character array part are displayed in different colors.

3. The typing game machine according to claim 1, wherein the correct character array part is displayed recognizably and the incorrect character array part is displayed unrecognizably.

4. The typing game machine according to claim 3, wherein a predetermined symbol is displayed over the unrecognizably-displayed incorrect character array part.

5. The typing game machine according to claim 1, further comprising:
a storage device for storing music data; and
a speaker,
wherein the predetermined character array relates to a voice being selected from the music data and outputted from the speaker.
